(19) United States
(12) Patent Application Publication
(10) Pub. No.: US 2021/0050585 A1
(43) Pub. Date: Feb. 18, 2021

(54) Systems and Methods of Making Solid-State Batteries and Associated Solid-State Battery Cathodes

(71) Applicant: TeraWatt Technology Inc., Santa Clara, CA (US)

(72) Inventors: Masatsugu Nakano, Tokyo (JP); Yang Yang, Tokyo (JP)

(21) Appl. No.: 16/542,254

(22) Filed: Aug. 15, 2019

(51) Int. Cl. H01M 4/13; H01M 10/0585; H01M 4/62; H01M 10/0562; H01M 4/36; H01M 10/052

(52) U.S. Cl. CPC H01M 4/13; H01M 10/0585; H01M 4/625; H01M 2004/021; H01M 4/366; H01M 10/052; H01M 10/0562

(57) ABSTRACT

Various embodiments and methods related to solid-state battery and associated solid-state battery cathodes are presented. The solid-state battery may include a solid-state battery cathode, a solid-state battery anode, and a solid electrolyte separator. The solid-state battery cathode may include an active material. The active material may include a plurality of particles characterized by a D50 diameter from about 10 μm to about 200 μm. The plurality of particles may include a microstructure formed from a plurality of crystalline grains. In some embodiments, the plurality of crystalline grains may be characterized by a D50 diameter of from about 2 nm to about 25 nm. The solid-state battery cathode may also include a solid-state interfacial coating coated on to the plurality of particles. The solid-state interfacial coating may include a crystalline material.

### BACKGROUND

As battery technology has become more advanced so have the use of batteries within electric vehicles (EV). In some instances, such as commuter vehicles, EVs aim to replace traditional gas-combustion vehicles as EVs offer a more environmental friendly solution. However, in order for EVs to eventually replace gas-combustion vehicles, EVs must be able comparably operate. One possible drawback of EVs is their reduction in driving range and temperature sensitivity, especially in cold conditions. Limiting weight and space requirements of EVs restrict the amount of batteries onboard EV. Moreover, current battery-technology used with EVs pose safety concerns due to the exothermic and combustible nature of the batteries. Hence, energy capacity, safety, and size are important properties of batteries within EVs. Therefore, there is a need for improved energy capacity, safety and size requirements of batteries within EVs.

### SUMMARY

Various embodiments are described related to solid-state battery and associated solid-state battery cathodes. The solid-state battery may include a solid-state battery cathode, a solid-state battery anode, and a solid electrolyte separator. In some embodiments, the solid-state battery anode may include a solid electrolyte powder and a plurality of anode particles mixed with the solid electrolyte powder to form the solid-state battery anode. The solid-state electrolyte separator may be positioned between the solid-state battery and the solid-state battery anode to form the solid-state battery. In some embodiments, the solid-state battery may have an initial capacity of at or above 125 mAh/g at 0.1 C and a rate performance of at or above 75% at a C-rate of 2 C and 0.1 C.

The solid-state battery cathode may include an active material. The active material may include a plurality of particles which form the solid-state battery cathode. The plurality of particles may be characterized by a D50 diameter from about 10 μm to about 200 μm and may include a microstructure formed from a plurality of crystalline grains. In some embodiments, the plurality of crystalline grains forming the microstructure of the plurality of particles may be characterized by a D50 diameter from about 2 nm to about 25 nm. The solid-state battery cathode may also include a solid-state interfacial coating. The plurality of particles may be coated with the solid-state interfacial coating. The solid-state interfacial coating may include a crystalline material.

A solid-state battery cathode may also be described herein. The solid-state battery cathode may include a solid electrolyte powder and an active material. In some embodiments, the solid electrolyte powder may include a sulfur-based solid electrolyte. The active material may include a plurality of particles mixed with the solid electrolyte powder to form the solid-state battery cathode. The plurality of particles may be characterized by a D50 diameter from about 10 μm to about 200 μm. In some embodiments, the plurality of particles may be characterized by a spherical shape. The plurality of particles may include a microstructure formed from a plurality of crystalline grains. In some embodiments, the plurality of crystalline grains may be characterized by a diameter from about 2 μm to about 25 μm.

The solid-state battery cathode may also include a solid-state interfacial coating. The solid-state interfacial coating may include a crystalline material. The solid-state interfacial coating may be coated on to the plurality of particles to reduce interfacial reactivity between the plurality of particles and the solid electrolyte powder within the solid-state battery cathode. In some embodiments, the solid-state interfacial coating may include graphene. Optionally, the solid-state battery cathode may include a plurality of conductive fibers. The plurality of conductive fibers may be interspersed between the plurality of particles within the solid-state battery cathode. In some embodiments, the plurality of conductive fibers may include vapor grown carbon fibers.

In some embodiments, a method for making a solid-state battery cathode may be described. The method may include providing an active material and filtering the active material to form a plurality of particles. The plurality of particles may be characterized by a D50 diameter from about 10 μm to about 200 μm. The method may also include coating the plurality of particles with an interfacial coating. In some embodiments, coating the plurality of particles may include spray coating the plurality of particles in a fluidized bed with a coating solution. Optionally, the coating solution may include LiOH, Zr(t-BuO)₄, or ethanol.

The method for making the solid-state battery cathode may also include forming a plurality of crystalline grains within the plurality of particles. The plurality of crystalline grains may be formed by heating the plurality of particles to a temperature from about 350° C. to about 600° C. In some embodiments, heating the plurality of particles may include calcination. Optionally, the plurality of crystalline grains may be characterized by a diameter of from about 20 nm to about 150 nm. The method may also include mixing a solid electrolyte powder with the plurality of particles to form a dry cathode mixture. In some embodiments, mixing the solid electrolyte powder with the plurality of particles may include dissolving the solid electrolyte powder in an electrolyte solvent to form an electrolyte solution. In some embodiments, the concentration of solid electrolyte powder in the electrolyte solution may be from about 15 mol % to about 30 mol %. Optionally, the electrolyte solution may include anhydrous N-methylformamide. Once the electrolyte solution is formed, the plurality of particles may be mixed with the electrolyte solution to form a cathode solution. The cathode solution may be dried to form a cathode composite. In some embodiments, drying the cathode solution may include maintaining the cathode solution at a temperature of from about 100° C. to 200° C. for about 1 hour to 3 hours under vacuum. After the cathode composite is formed by drying the cathode solution, the cathode composite may be pressed to form the solid-state battery cathode.

### BRIEF DESCRIPTION OF THE DRAWINGS

FIG. 1 illustrates a conventional lithium-ion battery according to some embodiments as disclosed herein.

FIG. 2 illustrates an example solid-state battery according to some embodiments as disclosed herein.

FIG. 3A illustrates a solid-state battery cathode having large particles according to some embodiments as disclosed herein.

FIG. 3B illustrates a solid-state battery cathode according to some embodiments as disclosed herein.

FIG. 4 illustrates a plurality of particles present within a solid-state battery cathode according to some embodiments as disclosed herein.

FIG. 5A illustrates interfacial reactions occurring within a solid-state battery cathode according to some embodiments as disclosed herein.

FIG. 5B illustrates a solid-state battery cathode according to some embodiments as disclosed herein.

FIG. 6A illustrates an electron pathway within a solid-state battery cathode lacking conductive fibers according to some embodiments as disclosed herein.

FIG. 6B illustrates an electron pathway within a solid-state battery cathode including conductive fibers according to some embodiments as disclosed herein.

FIG. 7 illustrates a flowchart of a method for making a solid-state battery cathode according to some embodiments as disclosed herein.

FIG. 8A illustrates filtering an active material as part of a method for making a solid-state battery cathode according to some embodiments as disclosed herein.

FIG. 8B illustrates coating a plurality of particles as part of a method for making a solid-state battery cathode according to some embodiments as disclosed herein.

FIG. 8C illustrates adding a plurality of particles into an electrolyte solution as part of a method for making a solid-state battery cathode according to some embodiments as disclosed herein.

FIG. 8D illustrates soaking a plurality of particles into an electrolyte solution as part of a method for making a solid-state battery cathode according to some embodiments as disclosed herein.

FIG. 8E illustrates pressing a cathode composite to form a solid-state battery cathode as part of a method for making a solid-state battery cathode according to some embodiments as disclosed herein.

### DETAILED DESCRIPTION

Described herein, are embodiments for a solid-state battery and corresponding solid-state battery cathode. Sustainable energy as well as efficient and economical energy conversion and storage technologies have become important work in light of the rising environmental issues. Electrical energy storage technologies play a significant role in the demand for green and sustainable energy. Specifically, rechargeable batteries or secondary batteries, such as lithium-ion batteries, which allow for reversible conversion between electrical and chemical energy have been increasingly relied upon by numerous technologies requiring portable and uninterrupted power sources.

One industry that has been driving the demand for improved rechargeable batteries is the automobile industry. As environmental concerns shift vehicles from combustion-based to electric-based, there is a growing demand for batteries having high capacity and cyclability capabilities while reducing size and providing safe power. Presently, electric vehicles (EVs) typically utilize conventional lithium-ion batteries. However, conventional lithium-ion batteries have a few drawbacks. Pure EVs have yet to achieve cost parity with combustion-based vehicles, due in large part to battery cost and range capabilities. Both of these issues are significantly dependent on the battery energy density (i.e., capacity). Conventional lithium-ion batteries have limited energy density and thus to be utilized in EVs, larger volumes of batteries are typically required. Moreover, conventional lithium-ion batteries, especially those that use organic liquid electrolytes, suffer from problems of flammability, low ion selectivity, limited electrochemical stability, and reasonably short lifespans.

Solid-state lithium batteries show potential to mitigate these issues by replacing the liquid or gel electrolyte with a solid-state electrolyte. Solid-state batteries are widely accepted as promising candidates for next generation of batteries, especially for use in EVs, due to high energy density potential and superior safety performance. However, the energy density, rate capacity, and capacity retention of solid-state batteries remains poor, impeding their ultimate commercial usage. These poor properties are caused, in part, by high resistance at the electrode/electrolyte interface. High interfacial resistivity may be caused by a variety of factors, including (1) interfacial reactions between the solid-state electrode and solid-state battery cathode, (2) electrochemical decomposition of the solid-state electrolyte at the interface during cell cycling, and (3) poor interfacial contact between the solid-state electrolyte and the solid-state battery cathode. Accordingly, as provided herein, the performance, specifically the capacity, of solid-state batteries may be improved by reducing the interfacial resistance between the solid-state battery cathode and the solid-state electrolyte.

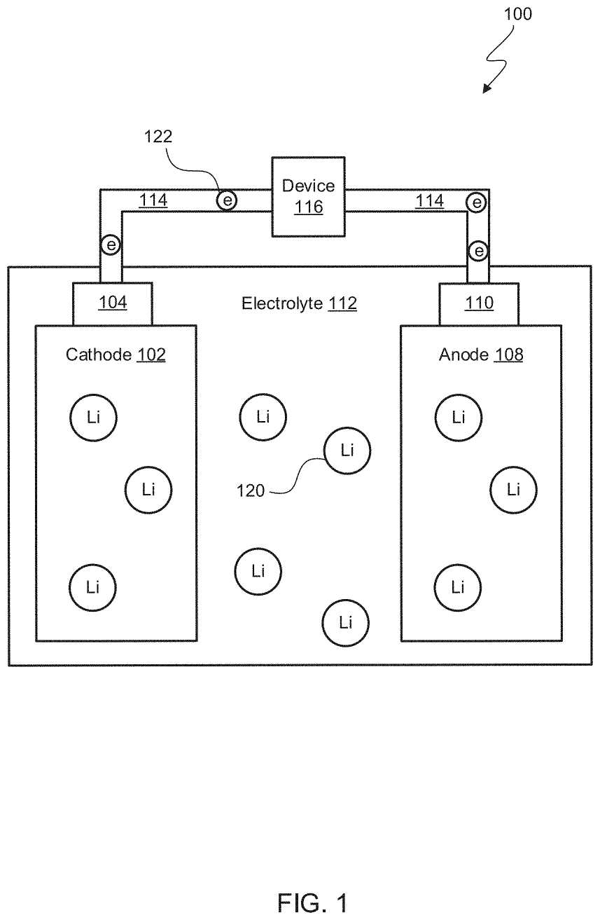

Further detail regarding such embodiments and additional embodiments is provided in relation to the figures. FIG. 1 depicts a conventional battery 100 that may be implemented by one or more embodiments. Conventional battery 100 may be a lithium-ion battery and produce electrical energy through electrochemical and/or chemical reactions. Conventional battery 100 may be a rechargeable battery (i.e., secondary battery) having reversible electrochemical capabilities such to allow for repeated charging and discharging cycles of conventional battery 100.

Conventional battery 100 may include a cathode 102, an anode 108, and an electrolyte 112. Conventional battery 100 may also include an electron path 114, and two terminals (current collectors) 104 and 110. The arrangement of conventional battery 100 and respective components may vary depending on the configuration of conventional battery 100. Cathode 102 may be a positive electrode and anode 108 may be a negative electrode. Cathode 102 may, prior to the initiation of a charging process, contain a plurality of lithium ions 120 (e.g., positively charged lithium ions; Li⁺). During the charging process, the lithium ions 120 intercalated within cathode 102 may flow, via electrolyte 112, to anode 108. During the discharging process the opposite may take place and lithium ions 120 intercalated within anode 108 may flow, via electrolyte 112, back to cathode 102.

As used herein, the terms intercalation, intercalated, and intercalate, may refer to a reversible inclusion or insertion of an ion (e.g., lithium ions 120) into a material having a layered or crystalline structure (lattices), such as anode 108 or cathode 102. Similarly, the terms deintercalation, deintercalated, and deintercalate, may refer to the reversible exclusion or expulsion of an ion (e.g., lithium ions 120) out of a material having a layered or crystalline structure (lattices).

Terminal 104 may be a current collector attached to cathode 102. Terminal 104 may be a positive current collector. Terminal 110 may be a current collector attached to anode 108. Terminal 110 may be a negative current collector. Terminals 104 and 110 may include various materials including, but not limited to, aluminum, nickel coated steel, and/or compounds based on aluminum, nickel, or any other suitable metal. During the charging process, when lithium ions 120 within cathode 102 flow from the cathode 102 to anode 108, electrons 122 may be “released.” Electrons 122 may flow from cathode 102 to terminal 104 and then from terminal 104, via electron path 114, to terminal 110. Because current flows in the opposite direction of electrons, terminal 104 may collect current during the charging process.

Electrolyte 112 may separate cathode 102 and anode 108 and prevent the electrodes from directly contacting one another. During the charging and discharging cycles, electrolyte 112 separating the cathode 102 and the anode 108 may prevent electron flow between the electrodes. By preventing electron flow between the anode 108 and the cathode 102, the electrons 122 may be forced to flow via electron path 114. Electron path 114 may be a path through which electrons 122 flow between cathode 102 and anode 108 because the electrons 122 cannot flow through electrolyte 112.

In some embodiments, device 116 may be attached to electron path 114 and during a discharging process electrons 122 flowing through electron path 114 (from anode 108 to cathode 102) may power device 116. In some embodiments, device 116 may only be attached to electron path 114 during a discharge process. In such embodiments, during a charging process when an external voltage is applied to conventional battery 100, device 116 may be directly powered or partially powered by the external voltage source.

Device 116 may be a parasitic load attached to conventional battery 100. Device 116 may operate based at least in part off of power produced by conventional battery 100. Device 116 may be various devices such as an electronic motor, a laptop, a computing device, a processor, and/or one or more electronic devices. Device 116 may not be a part of conventional battery 100, but instead relies on conventional battery 100 for electrical power. For example, device 116 may be an electronic motor that receives electric energy from conventional battery 100 via electron path 114 and device 116 may convert the electric energy into mechanical energy to perform one or more functions such as acceleration in an EV. During a charging process, when an external power source is connected to conventional battery 100, device 116 may be powered by the external power source (e.g., external to conventional battery 100). During a discharging process, when an external power source is not connected to conventional battery 100, device 116 may be powered by conventional battery 100.

Electrolytes, such as electrolyte 112, play a key role in transporting the lithium ions 120 between the cathode 102 and the anode 108. To allow movement of the lithium ions 120, electrolyte 112 needs to be conductive. In conventional lithium-ion batteries, such as conventional battery 100, the electrolyte 112 may be a liquid electrolyte. Liquid electrolytes typically have higher ionic conductivity than solid electrolytes. In some embodiments, electrolyte 112 may include soluble salts, acids or other bases in liquid or gelled formats. Exemplary electrolytes 112 may include a solution of lithium salts with organic solvents such as ethylene carbonate.

In addition to conductivity, ion diffusion between the electrolyte 112 and electrodes (i.e., anode 108 and cathode 102) is another important electrochemical property of an electrolyte. Interfacial contact between the electrolyte 112 and the electrodes must be adequately maintained to allow for ion diffusion. If there is a gap between the electrodes and electrolyte 112 (i.e., or poor interfacial contact), then the interfacial resistivity may be high and ion diffusion may be difficult. When the interfacial resistivity is high, then transfer of lithium ions 120 between the electrodes and electrolyte 112, and vice versa, may be impacted resulting in reduced battery capacity.

Liquid electrolytes, such as electrolyte 112, may be advantageous because of the ability of the liquid electrolyte to initiate and maintain intimate interfacial contact between electrolyte 112 and the electrodes (anode 108 and cathode 102). As illustrated in FIG. 1, anode 108 and cathode 102 are typically submerged in electrolyte 112 to enhance wetting (i.e., contact) of the electrodes. With a liquid electrolyte, the electrolyte may saturate the electrode structure, allowing for electrolyte 112 to penetrate into the electrode and access ions stored deep within the electrode structure. However, liquid electrolytes pose numerous safety concerns.

The format of electrolyte 112, whether it be liquid or gel, may require conventional battery 100 to have a large volume as well as be liquid tight. Liquid electrolytes, such as electrolyte 112, may have low thermal stability. Typically utilized liquid electrodes include combustible liquids such as organic carbonate esters or toxic lithium salts. Thus, any leakage of electrolyte 112 may be hazardous and pose safety concerns, especially when conventional battery 100 is used in EV applications.

Dendrite formation may also be problematic for electrolyte 112. Dendrites are branch-like growths of lithium metal, which occurs when lithium ions collect in localized areas on the electrode surface. During the charging cycle, lithium ions 120 move from cathode 102 to anode 108 and distribute unevenly on the surface of anode 108. With each subsequent charging cycle, lithium ions 120 find a path of least resistance, causing them to collect in localized areas that protrude from the surface of anode 108. These protrusions can grow long enough to span the distance between the electrodes, causing an internal electrical short circuit which may result in battery failure. Furthermore, short-circuiting often causes localized heating and, when using a liquid electrolyte with low thermal stability, that heat can quickly accelerate the onset of thermal runaway, which can lead in some cases to combustion of conventional battery 100.

Replacing liquid electrolytes, such as electrolyte 112, with a solid electrolyte may address the numerous issues posed by conventional battery 100. First, solid electrolytes have higher thermal stability, meaning that flammability concerns are reduced. Second, since solid electrolytes are solid, leakage and storage concerns are mitigated. Moreover, solid electrolytes allow for the overall size of the solid-state battery to be reduced as compared to conventional lithium-ion batteries because of the increased energy density of solid-state batteries. Third, solid electrolytes can physically suppress dendrite growth and alleviate the corresponding safety concerns. Overall, solid electrolytes can improve battery safety and performance due to their superior mechanical, electrochemical, and thermal stability when compared with liquid electrolytes.

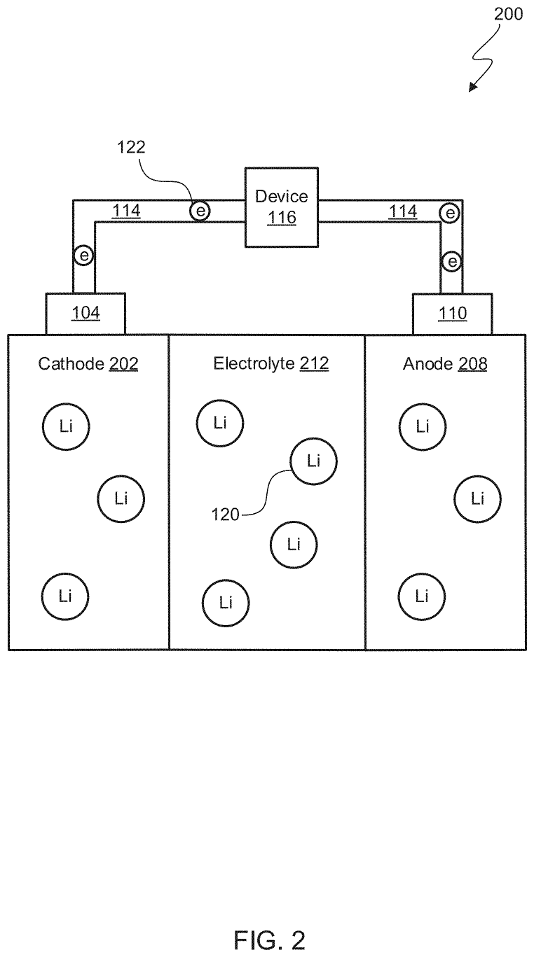

FIG. 2 depicts a solid-state battery 200 according to some embodiments provided herein. The solid-state battery 200 may be a lithium solid-state battery. Similar to conventional battery 100, solid-state battery 200 may include a solid-state battery cathode 202, a solid-state battery anode 208, and a solid-state electrolyte 212. However, unlike conventional battery 100, solid-state battery cathode 202, solid-state battery anode 208, and solid-state electrolyte 212 are all in a solid state (format). Solid-state battery 200 may produce electrical energy from electrochemical and/or chemical reactions. Additionally, solid-state battery 200 may be a rechargeable battery having reversible electrochemical capabilities allowing for repeated charging and discharging cycles with minimal impacts to the energy density or workable life of the solid-state battery 200.

The arrangement of solid-state battery 200 and respective components may vary depending on the configuration of solid-state battery 200. In some embodiments, the solid-state battery 200 may be cylindrical in shape having solid-state battery cathode 202 and solid-state battery anode 208 on a top surface or on opposite surfaces from one another. However, in other embodiments, solid-state battery 200 may be rectangular, square, button, in a pouch-like form, layered, or in a film state.

In embodiments, solid-state battery 200 may or be configured to power, completely or partially, device 116. Solid-state battery 200 may power device 116 via the same mechanism described with relation to FIG. 1. For example, solid-state battery 200 may power device 116 during a discharging process in which electrons 122 flow via electron path 114, while lithium ions 120 flow from solid-state battery anode 208, via solid-state electrolyte 212, to solid-state battery cathode 202. Similarly, during a charging process, solid-state battery 200 may be connected to an external power source which may apply an external voltage causing electrons 122 to flow, via electron path 114, from solid-state battery cathode 202 to solid-state battery anode 208. During a charging process, as the electrons 122 flow from the solid-state battery cathode 202 to the solid-state battery anode 208, via electron path 114, the lithium ions 120 may also flow from the solid-state battery cathode 202 to the solid-state battery anode 208, through solid-state electrolyte 212.

Solid-state battery cathode 202 may be a positive electrode comprised of different material types. The solid-state battery cathode 202 may include an active material or cathode material. The active material may be compatible with solid-state lithium-ion battery chemistry, having porous and conductive properties. The active material may be compatible with solid-state lithium-ion battery chemistry such that the active material may support efficient and effective charging and discharging cycles of solid-state battery cathode 202 without impacting the energy density or workable life of solid-state battery 200. In some embodiments, the cathode material may be compatible with lithium-ion battery chemistry such that little to no damage may occur to the solid-state battery 200. For example, the cathode material may allow solid-state battery 200 to maintain a consistent state of charge (or energy density) for 50 days with normal use.

The active material may include lithium-cobalt oxide (LiCoO₂), lithium iron phosphate (LiFePO₄), and/or another metal based alloy. In embodiments, active material may include layered oxides similar to LiCoO₂ but with added metals such as nickel, manganese and aluminum. For example, the active material may include NCA (nickel cobalt aluminum) and NMC (nickel manganese cobalt). In some embodiments, the solid-state battery cathode 202 may include a solid electrolyte powder. In such embodiments, the active material may be mixed with a solid electrolyte powder to form the solid-state battery cathode 202.

In some embodiments, solid-state battery cathode 202 may have a thickness from about 10 μm to about 500 μm, preferably from 30 μm to 200 μm, and most preferably from 50 μm to 150 μm. For example, the solid-state battery cathode 202 may have a thickness from about 25 μm to about 500 μm, from about 50 μm to about 500 μm, from about 75 μm to about 500 μm, from about 100 μm to about 500 μm, from about 125 μm to about 500 μm, from about 150 μm to about 500 μm, from about 175 μm to about 500 μm, from about 200 μm to about 500 μm, from about 225 μm to about 500 μm, from about 250 μm to about 500 μm, from about 275 μm to about 500 μm, from about 300 μm to about 500 μm, from about 325 μm to about 500 μm, from about 350 μm to about 500 μm, from about 375 μm to about 500 μm, from about 400 μm to about 500 μm, from about 425 μm to about 500 μm, from about 450 μm to about 500 μm, from about 475 μm to about 500 μm, from about 25 μm to about 475 μm, from about 50 μm to about 475 μm, from about 75 μm to about 475 μm, from about 100 μm to about 475 μm, from about 125 μm to about 475 μm, from about 150 μm to about 475 μm, from about 175 μm to about 475 μm, from about 200 μm to about 475 μm, from about 225 μm to about 475 μm, from about 250 μm to about 475 μm, from about 275 μm to about 475 μm, from about 300 μm to about 475 μm, from about 325 μm to about 475 μm, from about 350 μm to about 475 μm, from about 375 μm to about 475 μm, from about 400 μm to about 475 μm, from about 425 μm to about 475 μm, from about 450 μm to about 475 μm, from about 25 μm to about 450 μm, from about 50 μm to about 450 μm, from about 75 μm to about 450 μm, from about 100 μm to about 450 μm, from about 125 μm to about 450 μm, from about 150 μm to about 450 μm, from about 175 μm to about 450 μm, from about 200 μm to about 450 μm, from about 225 μm to about 450 μm, from about 250 μm to about 450 μm, from about 275 μm to about 450 μm, from about 300 μm to about 450 μm, from about 325 μm to about 450 μm, from about 350 μm to about 450 μm, from about 375 μm to about 450 μm, from about 400 μm to about 450 μm, from about 425 μm to about 450 μm, from about 25 μm to about 425 μm, from about 50 μm to about 425 μm, from about 75 μm to about 425 μm, from about 100 μm to about 425 μm, from about 125 μm to about 425 μm, from about 150 μm to about 425 μm, from about 175 μm to about 425 μm, from about 200 μm to about 425 μm, from about 225 μm to about 425 μm, from about 250 μm to about 425 μm, from about 275 μm to about 425 μm, from about 300 μm to about 425 μm, from about 325 μm to about 425 μm, from about 350 μm to about 425 μm, from about 375 μm to about 425 μm, from about 400 μm to about 425 μm, from about 25 μm to about 400 μm, from about 50 μm to about 400 μm, from about 75 μm to about 400 μm, from about 100 μm to about 400 μm, from about 125 μm to about 400 μm, from about 150 μm to about 400 μm, from about 175 μm to about 400 μm, from about 200 μm to about 400 μm, from about 225 μm to about 400 μm, from about 250 μm to about 400 μm, from about 275 μm to about 400 μm, from about 300 μm to about 400 μm, from about 325 μm to about 400 μm, from about 350 μm to about 400 μm, from about 375 μm to about 400 μm, from about 25 μm to about 375 μm, from about 50 μm to about 375 μm, from about 75 μm to about 375 μm, from about 100 μm to about 375 μm, from about 125 μm to about 375 μm, from about 150 μm to about 375 μm, from about 175 μm to about 375 μm, from about 200 μm to about 375 μm, from about 225 μm to about 375 μm, from about 250 μm to about 375 μm, from about 275 μm to about 375 μm, from about 300 μm to about 375 μm, from about 325 μm to about 375 μm, from about 350 μm to about 375 μm, from about 25 μm to about 350 μm, from about 50 μm to about 350 μm, from about 75 μm to about 350 μm, from about 100 μm to about 350 μm, from about 125 μm to about 350 μm, from about 150 μm to about 350 μm, from about 175 μm to about 350 μm, from about 200 μm to about 350 μm, from about 225 μm to about 350 μm, from about 250 μm to about 350 μm, from about 275 μm to about 350 μm, from about 300 μm to about 350 μm, from about 325 μm to about 350 μm, from about 25 μm to about 325 μm, from about 50 μm to about 325 μm, from about 75 μm to about 325 μm, from about 100 μm to about 325 μm, from about 125 μm to about 325 μm, from about 150 μm to about 325 μm, from about 175 μm to about 325 μm, from about 200 μm to about 325 μm, from about 225 μm to about 325 μm, from about 250 μm to about 325 μm, from about 275 μm to about 325 μm, from about 300 μm to about 325 μm, from about 25 μm to about 300 μm, from about 50 μm to about 300 μm, from about 75 μm to about 300 μm, from about 100 μm to about 300 μm, from about 125 μm to about 300 μm, from about 150 μm to about 300 μm, from about 175 μm to about 300 μm, from about 200 μm to about 300 μm, from about 225 μm to about 300 μm, from about 250 μm to about 300 μm, from about 275 μm to about 300 μm, from about 25 μm to about 275 μm, from about 50 μm to about 275 μm, from about 75 μm to about 275 μm, from about 100 μm to about 275 μm, from about 125 μm to about 275 μm, from about 150 μm to about 275 μm, from about 175 μm to about 275 μm, from about 200 μm to about 275 μm, from about 225 μm to about 275 μm, from about 250 μm to about 275 μm, from about 25 μm to about 250 μm, from about 50 μm to about 250 μm, from about 75 μm to about 250 μm, from about 100 μm to about 250 μm, from about 125 μm to about 250 μm, from about 150 μm to about 250 μm, from about 175 μm to about 250 μm, from about 200 μm to about 250 μm, from about 225 μm to about 250 μm, from about 25 μm to about 225 μm, from about 50 μm to about 225 μm, from about 75 μm to about 225 μm, from about 100 μm to about 225 μm, from about 125 μm to about 225 μm, from about 150 μm to about 225 μm, from about 175 μm to about 225 μm, from about 200 μm to about 225 μm, from about 25 μm to about 200 μm, from about 50 μm to about 200 μm, from about 75 μm to about 200 μm, from about 100 μm to about 200 μm, from about 125 μm to about 200 μm, from about 150 μm to about 200 μm, from about 175 μm to about 200 μm, from about 25 μm to about 175 μm, from about 50 μm to about 175 μm, from about 75 μm to about 175 μm, from about 100 μm to about 175 μm, from about 125 μm to about 175 μm, from about 150 μm to about 175 μm, from about 25 μm to about 150 μm, from about 50 μm to about 150 μm, from about 75 μm to about 150 μm, from about 100 μm to about 150 μm, from about 125 μm to about 150 μm, from about 25 μm to about 125 μm, from about 50 μm to about 125 μm, from about 75 μm to about 125 μm, from about 100 μm to about 125 μm, from about 25 μm to about 100 μm, from about 50 μm to about 100 μm, from about 75 μm to about 100 μm, from about 25 μm to about 75 μm, from about 50 μm to about 75 μm, or from about 25 μm to about 50 μm.

Solid-state battery anode 208 may be a negative electrode comprised of different material types. For example, solid-state battery anode 208 may include an anode material. The anode material may be compatible with solid-state lithium-ion battery chemistry, having porous and conductive properties. The anode material may be compatible with solid-state lithium-ion battery chemistry such that the anode material may support efficient and effective charging and discharging cycles of solid-state battery anode 208 without impacting the energy density or workable life of solid-state battery 200. In some embodiments, the anode material may be compatible with lithium-ion battery chemistry such that little to no damage may occur to the solid-state battery 200. For example, the anode material may allow solid-state battery 200 to maintain a consistent state of charge (or energy density) for 50 days with normal use.

The anode material may include one or more carbonaceous material, such as a graphite material (natural or synthetic), cokes, carbon and graphite fibers, or pyrolysis carbons. In some embodiments, the anode material include a graphite material comprising meso-carbon microbeads (MCMB). Optionally, solid-state battery anode 208 may include a silicon-containing material. In some cases, both the carbonaceous material, such as the graphite material, and the silicon-containing material may be present in solid-state battery anode 208. For example, the anode material may include both a silicon-containing material and MCMB. In embodiments, the silicon-containing material may include a silicon oxide (SiOₓ), silicene, silicon carbon composites, such as silicon carbide (SiC), or nanocrystalline Si. In embodiments, anode 108 may include additional materials. For example, solid-state battery anode 208 may include a solid electrolyte powder, a lithium metal (e.g., lithium titanate, lithium metal, or lithium-tin alloys), and/or a plurality of conductive fibers.

In some embodiments, solid-state battery anode 208 may have a thickness from about 10 μm to about 500 μm, preferably from 30 μm to 200 μm, and most preferably from 50 μm to 150 μm. For example, the solid-state battery anode 208 may have a thickness from about 25 μm to about 500 μm, from about 50 μm to about 500 μm, from about 75 μm to about 500 μm, from about 100 μm to about 500 μm, from about 125 μm to about 500 μm, from about 150 μm to about 500 μm, from about 175 μm to about 500 μm, from about 200 μm to about 500 μm, from about 225 μm to about 500 μm, from about 250 μm to about 500 μm, from about 275 μm to about 500 μm, from about 300 μm to about 500 μm, from about 325 μm to about 500 μm, from about 350 μm to about 500 μm, from about 375 μm to about 500 μm, from about 400 μm to about 500 μm, from about 425 μm to about 500 μm, from about 450 μm to about 500 μm, from about 475 μm to about 500 μm, from about 25 μm to about 475 μm, from about 50 μm to about 475 μm, from about 75 μm to about 475 μm, from about 100 μm to about 475 μm, from about 125 μm to about 475 μm, from about 150 μm to about 475 μm, from about 175 μm to about 475 μm, from about 200 μm to about 475 μm, from about 225 μm to about 475 μm, from about 250 μm to about 475 μm, from about 275 μm to about 475 μm, from about 300 μm to about 475 μm, from about 325 μm to about 475 μm, from about 350 μm to about 475 μm, from about 375 μm to about 475 μm, from about 400 μm to about 475 μm, from about 425 μm to about 475 μm, from about 450 μm to about 475 μm, from about 25 μm to about 450 μm, from about 50 μm to about 450 μm, from about 75 μm to about 450 μm, from about 100 μm to about 450 μm, from about 125 μm to about 450 μm, from about 150 μm to about 450 μm, from about 175 μm to about 450 μm, from about 200 μm to about 450 μm, from about 225 μm to about 450 μm, from about 250 μm to about 450 μm, from about 275 μm to about 450 μm, from about 300 μm to about 450 μm, from about 325 μm to about 450 μm, from about 350 μm to about 450 μm, from about 375 μm to about 450 μm, from about 400 μm to about 450 μm, from about 425 μm to about 450 μm, from about 25 μm to about 425 μm, from about 50 μm to about 425 μm, from about 75 μm to about 425 μm, from about 100 μm to about 425 μm, from about 125 μm to about 425 μm, from about 150 μm to about 425 μm, from about 175 μm to about 425 μm, from about 200 μm to about 425 μm, from about 225 μm to about 425 μm, from about 250 μm to about 425 μm, from about 275 μm to about 425 μm, from about 300 μm to about 425 μm, from about 325 μm to about 425 μm, from about 350 μm to about 425 μm, from about 375 μm to about 425 μm, from about 400 μm to about 425 μm, from about 25 μm to about 400 μm, from about 50 μm to about 400 μm, from about 75 μm to about 400 μm, from about 100 μm to about 400 μm, from about 125 μm to about 400 μm, from about 150 μm to about 400 μm, from about 175 μm to about 400 μm, from about 200 μm to about 400 μm, from about 225 μm to about 400 μm, from about 250 μm to about 400 μm, from about 275 μm to about 400 μm, from about 300 μm to about 400 μm, from about 325 μm to about 400 μm, from about 350 μm to about 400 μm, from about 375 μm to about 400 μm, from about 25 μm to about 375 μm, from about 50 μm to about 375 μm, from about 75 μm to about 375 μm, from about 100 μm to about 375 μm, from about 125 μm to about 375 μm, from about 150 μm to about 375 μm, from about 175 μm to about 375 μm, from about 200 μm to about 375 μm, from about 225 μm to about 375 μm, from about 250 μm to about 375 μm, from about 275 μm to about 375 μm, from about 300 μm to about 375 μm, from about 325 μm to about 375 μm, from about 350 μm to about 375 μm, from about 25 μm to about 350 μm, from about 50 μm to about 350 μm, from about 75 μm to about 350 μm, from about 100 μm to about 350 μm, from about 125 μm to about 350 μm, from about 150 μm to about 350 μm, from about 175 μm to about 350 μm, from about 200 μm to about 350 μm, from about 225 μm to about 350 μm, from about 250 μm to about 350 μm, from about 275 μm to about 350 μm, from about 300 μm to about 350 μm, from about 325 μm to about 350 μm, from about 25 μm to about 325 μm, from about 50 μm to about 325 μm, from about 75 μm to about 325 μm, from about 100 μm to about 325 μm, from about 125 μm to about 325 μm, from about 150 μm to about 325 μm, from about 175 μm to about 325 μm, from about 200 μm to about 325 μm, from about 225 μm to about 325 μm, from about 250 μm to about 325 μm, from about 275 μm to about 325 μm, from about 300 μm to about 325 μm, from about 25 μm to about 300 μm, from about 50 μm to about 300 μm, from about 75 μm to about 300 μm, from about 100 μm to about 300 μm, from about 125 μm to about 300 μm, from about 150 μm to about 300 μm, from about 175 μm to about 300 μm, from about 200 μm to about 300 μm, from about 225 μm to about 300 μm, from about 250 μm to about 300 μm, from about 275 μm to about 300 μm, from about 25 μm to about 275 μm, from about 50 μm to about 275 μm, from about 75 μm to about 275 μm, from about 100 μm to about 275 μm, from about 125 μm to about 275 μm, from about 150 μm to about 275 μm, from about 175 μm to about 275 μm, from about 200 μm to about 275 μm, from about 225 μm to about 275 μm, from about 250 μm to about 275 μm, from about 25 μm to about 250 μm, from about 50 μm to about 250 μm, from about 75 μm to about 250 μm, from about 100 μm to about 250 μm, from about 125 μm to about 250 μm, from about 150 μm to about 250 μm, from about 175 μm to about 250 μm, from about 200 μm to about 250 μm, from about 225 μm to about 250 μm, from about 25 μm to about 225 μm, from about 50 μm to about 225 μm, from about 75 μm to about 225 μm, from about 100 μm to about 225 μm, from about 125 μm to about 225 μm, from about 150 μm to about 225 μm, from about 175 μm to about 225 μm, from about 200 μm to about 225 μm, from about 25 μm to about 200 μm, from about 50 μm to about 200 μm, from about 75 μm to about 200 μm, from about 100 μm to about 200 μm, from about 125 μm to about 200 μm, from about 150 μm to about 200 μm, from about 175 μm to about 200 μm, from about 25 μm to about 175 μm, from about 50 μm to about 175 μm, from about 75 μm to about 175 μm, from about 100 μm to about 175 μm, from about 125 μm to about 175 μm, from about 150 μm to about 175 μm, from about 25 μm to about 150 μm, from about 50 μm to about 150 μm, from about 75 μm to about 150 μm, from about 100 μm to about 150 μm, from about 125 μm to about 150 μm, from about 25 μm to about 125 μm, from about 50 μm to about 125 μm, from about 75 μm to about 125 μm, from about 100 μm to about 125 μm, from about 25 μm to about 100 μm, from about 50 μm to about 100 μm, from about 75 μm to about 100 μm, from about 25 μm to about 75 μm, from about 50 μm to about 75 μm, or from about 25 μm to about 50 μm.

Solid-state electrolyte 212 may separate solid-state battery cathode 202 and solid-state battery anode 208 while allowing lithium ions 120 to flow between solid-state battery cathode 202 and solid-state battery anode 208. In such embodiments, solid-state electrolyte 212 may be a solid electrolyte separator positioned between solid-state battery cathode 202 and solid-state battery anode 208. Solid-state electrolyte 212 may inhibit electrons 122 from transferring or moving between solid-state battery anode 208 and solid-state battery cathode 202, and force or induce electrons 122 to travel along electron path 114, as described above.

In some embodiments, solid-state electrolyte 212 may have a thickness from about 10 μm to about 1,000 mm. In some embodiments, the solid-state electrolyte 212 may have a thickness from about 20 μm to 200 μm. However, thickness is not restrained this range. A thin thickness range may be preferable to obtain a high energy density solid-state battery. For example, the solid-state electrolyte 212 may have a thickness from about 10 μm to about 1,000 mm, from about 25 μm to about 1,000 mm, from about 50 μm to about 1,000 mm, from about 100 μm to about 1,000 mm, from about 150 μm to about 1,000 mm, from about 200 μm to about 1,000 mm, from about 250 μm to about 1,000 mm, from about 300 μm to about 1,000 mm, from about 350 μm to about 1,000 mm, from about 300 μm to about 1,000 mm, from about 350 μm to about 1,000 mm, from about 400 μm to about 1,000 mm, from about 450 μm to about 1,000 mm, from about 500 μm to about 1,000 mm, from about 550 μm to about 1,000 mm, from about 600 μm to about 1,000 mm, from about 650 μm to about 1,000 mm, from about 700 μm to about 1,000 mm, from about 750 μm to about 1,000 mm, from about 800 μm to about 1,000 mm, from about 850 μm to about 1,000 mm, from about 900 μm to about 1,000 mm, from about 950 μm to about 1,000 mm, from about 10 μm to about 950 μm, from about 25 μm to about 950 μm, from about 50 μm to about 950 μm, from about 100 μm to about 950 μm, from about 150 μm to about 950 μm, from about 200 μm to about 950 μm, from about 250 μm to about 950 μm, from about 300 μm to about 950 μm, from about 350 μm to about 950 μm, from about 400 μm to about 950 μm, from about 450 μm to about 950 μm, from about 500 μm to about 950 μm, from about 550 μm to about 950 μm, from about 600 μm to about 950 μm, from about 650 μm to about 950 μm, from about 700 μm to about 950 μm, from about 750 μm to about 950 μm, from about 800 μm to about 950 μm, from about 850 μm to about 950 μm, from about 900 μm to about 950 μm, from about 10 μm to about 900 μm, from about 25 μm to about 900 μm, from about 50 μm to about 900 μm, from about 100 μm to about 900 μm, from about 150 μm to about 900 μm, from about 200 μm to about 900 μm, from about 250 μm to about 900 μm, from about 300 μm to about 900 μm, from about 350 μm to about 900 μm, from about 400 μm to about 900 μm, from about 450 μm to about 900 μm, from about 500 μm to about 900 μm, from about 550 μm to about 900 μm, from about 600 μm to about 900 μm, from about 650 μm to about 900 μm, from about 700 μm to about 900 μm, from about 750 μm to about 900 μm, from about 800 μm to about 900 μm, from about 850 μm to about 900 μm, from about 10 μm to about 850 mm, from about 25 μm to about 850 μm, from about 50 μm to about 850 μm, from about 100 μm to about 850 μm, from about 150 μm to about 850 μm, from about 200 μm to about 850 μm, from about 250 μm to about 850 μm, from about 300 μm to about 850 μm, from about 350 μm to about 850 μm, from about 400 μm to about 850 μm, from about 450 μm to about 850 μm, from about 500 μm to about 850 μm, from about 550 μm to about 850 μm, from about 600 μm to about 850 μm, from about 650 μm to about 850 μm, from about 700 μm to about 850 μm, from about 750 μm to about 850 μm, from about 800 μm to about 850 μm, from about 10 μm to about 800 μm, from about 25 μm to about 800 μm, from about 50 μm to about 800 μm, from about 100 μm to about 800 μm, from about 250 μm to about 800 μm, from about 300 μm to about 800 μm, from about 350 μm to about 800 μm, from about 400 μm to about 800 μm, from about 450 μm to about 800 μm, from about 500 μm to about 800 μm, from about 550 μm to about 800 μm, from about 600 μm to about 800 μm, from about 650 μm to about 800 μm, from about 700 μm to about 800 μm, from about 750 μm to about 800 μm, from about 10 μm to about 750 μm, from about 25 μm to about 750 μm, from about 50 μm to about 750 μm, from about 100 μm to about 750 μm, from about 250 μm to about 750 μm, from about 300 μm to about 750 μm, from about 350 μm to about 750 μm, from about 400 μm to about 750 μm, from about 450 μm to about 750 μm, from about 500 μm to about 750 μm, from about 550 μm to about 750 μm, from about 600 μm to about 750 μm, from about 650 μm to about 750 μm, from about 700 μm to about 750 μm, from about 10 μm to about 700 μm, from about 25 μm to about 700 μm, from about 50 μm to about 700 μm, from about 100 μm to about 700 μm, from about 250 μm to about 700 μm, from about 300 μm to about 700 μm, from about 350 μm to about 700 μm, from about 400 μm to about 700 μm, from about 450 μm to about 700 μm, from about 500 μm to about 700 μm, from about 550 μm to about 700 μm, from about 600 μm to about 700 μm, from about 650 μm to about 700 μm, from about 10 μm to about 650 μm, from about 25 μm to about 650 μm, from about 50 μm to about 650 μm, from about 100 μm to about 650 μm, from about 150 μm to about 650 μm, from about 250 μm to about 650 μm, from about 300 μm to about 650 μm, from about 350 μm to about 650 μm, from about 400 μm to about 650 μm, from about 450 μm to about 650 μm, from about 500 μm to about 650 μm, from about 550 μm to about 650 μm, from about 600 μm to about 650 μm, from about 10 μm to about 600 μm, from about 25 μm to about 600 μm, from about 50 μm to about 600 μm, from about 100 μm to about 600 μm, from about 150 μm to about 600 μm, from about 250 μm to about 600 μm, from about 300 μm to about 600 μm, from about 350 μm to about 600 μm, from about 400 μm to about 600 μm, from about 450 μm to about 600 μm, from about 500 μm to about 600 μm, from about 550 μm to about 600 μm, from about 10 μm to about 550 μm, from about 25 μm to about 550 μm, from about 50 μm to about 550 μm, from about 100 μm to about 550 μm, from about 150 μm to about 550 μm, from about 250 μm to about 550 μm, from about 300 μm to about 550 μm, from about 350 μm to about 550 μm, from about 400 μm to about 550 μm, from about 450 μm to about 550 μm, from about 500 μm to about 550 μm, from about 10 μm to about 500 μm, from about 25 μm to about 500 μm, from about 50 μm to about 500 μm, from about 100 μm to about 500 μm, from about 150 μm to about 500 μm, from about 250 μm to about 500 μm, from about 300 μm to about 500 μm, from about 350 μm to about 500 μm, from about 400 μm to about 500 μm, from about 450 μm to about 500 μm, from about 10 μm to about 450 μm, from about 25 μm to about 450 μm, from about 50 μm to about 450 μm, from about 100 μm to about 450 μm, from about 150 μm to about 450 μm, from about 200 μm to about 450 μm, from about 250 μm to about 450 μm, from about 300 μm to about 450 μm, from about 350 μm to about 450 μm, from about 400 μm to about 450 μm, from about 10 μm to about 400 μm, from about 25 μm to about 400 μm, from about 50 μm to about 400 μm, from about 100 μm to about 400 μm, from about 150 μm to about 400 μm, from about 200 μm to about 400 μm, from about 250 μm to about 400 μm, from about 300 μm to about 400 μm, from about 350 μm to about 400 μm, from about 10 μm to about 350 μm, from about 25 μm to about 350 μm, from about 50 μm to about 350 μm, from about 100 μm to about 350 μm, from about 150 μm to about 350 μm, from about 200 μm to about 350 μm, from about 250 μm to about 350 μm, from about 300 μm to about 350 μm, from about 10 μm to about 300 μm, from about 25 μm to about 300 μm, from about 50 μm to about 300 μm, from about 100 μm to about 300 μm, from about 150 μm to about 300 μm, from about 200 μm to about 300 μm, from about 250 μm to about 300 μm, from about 10 μm to about 250 μm, from about 25 μm to about 250 μm, from about 50 μm to about 250 μm, from about 100 μm to about 250 μm, from about 150 μm to about 250 μm, from about 200 μm to about 250 μm, from about 10 μm to about 200 μm, from about 25 μm to about 200 μm, from about 50 μm to about 200 μm, from about 100 μm to about 200 μm, from about 150 μm to about 200 μm, from about 10 μm to about 150 μm, from about 25 μm to about 150 μm, from about 50 μm to about 150 μm, from about 100 μm to about 150 μm, from about 10 μm to about 100 μm, from about 25 μm to about 100 μm, from about 50 μm to about 100 μm, from about 10 μm to about 50 μm, from about 25 μm to about 50 μm, or from about 10 μm to about 25 μm.

As the name indicates, solid-state electrolyte 212 may be a solid electrolyte. Solid-state electrolyte 212 may include a polymer solid-state electrolyte, a solid electrolyte powder, such as an inorganic solid-state electrolyte, or a sulfur based electrolyte. Exemplary polymer solid-state electrolytes may include polyethylene oxide (POE), which may contain a lithium salt, such as lithium hexafluorophosphate (LiPF₆), lithium bis(trifluoromethanesulfonyl)imide (LiTFSI), lithium bis(fluorosulfonyl)imide (LiFSI), lithium bis(oxalate)borate (LiBOB), lithium tetrafluoroborate (LiBF₄), and lithium perchlorate (LiClO₄). Exemplary inorganic solid-state electrolytes may include an oxide such as lithium aluminum titanium phosphate (LATP; Li₁₊ₓAl_{y}Ti_{2-y}PO₄.), for example Li_{1.3}Al_{0.3}Ti_{11.7}(PO₄)₃, a lithium aluminum germanium phosphate (LAGP), for example Li_{1.5}Al_{0.5}Ge_{1.5}P₃O₁₂, Li_{1.3}Al_{0.3}Ge_{1.7}(PO₄)₃ or Li_{1.5}Al_{0.5}Ge_{1.5}(PO₄)₃, a lithium phosphorous oxy-nitride (LiPON), for example Li_{2.9}PO_{3.3}N_{0.4}, or a lithium lanthanum zirconate oxide (LLZO), for example Li₇La₃Zr₂O₁₂. Inorganic solid-state electrolytes may also include complex hydrides, such as iodide substitution in lithium borohydride (LiBH₄—LiI) or lithium nitride (Li₃N). In embodiments, solid-state electrolyte 212 may include a sulfur-based solid electrolyte. Exemplary sulfur-based solid electrolytes may include a lithium germanium phosphorous sulfide (LGPS), such as Li₁₀GeP₂S₁₂ or a lithium phosphorus sulfide (LPS), such as Li₂S—P₂S₅.

As noted above, solid electrolytes, such as solid-state electrolyte 212, may improve battery safety over conventional lithium-ion batteries, such as conventional battery 100. However, the physical limitations of solid electrolytes may make them inherently less conductive than their liquid counterparts due to the slowed ion diffusion through the solid medium. High interfacial resistance between the electrodes and electrolyte surfaces may make ion diffusion difficult in solid-state batteries, such as solid-state battery 200. The interfacial resistance may be due to poor contact between the solid surfaces (of the electrodes and electrolyte) and/or the poor penetration of electrolyte into the porous anode. With a liquid electrolyte, like electrolyte 112, the electrolyte is free to saturate the electrode structure. This allows for utilization of lithium ions 120 which have intercalated deep within the electrode structure. However, when a solid electrolyte is used, the electrode-electrolyte interface may be greatly reduced and the number of usable lithium ions available to transfer charge may be significantly restricted. Typically, the way to overcome this challenge is to introduce a small amount of liquid electrolyte at the electrode-electrolyte interface to reduce that interfacial resistance. This, however, defeats the purpose of using a solid electrolyte to improve battery safety.

The solid-state battery cathode 202, as provided herein, may increase interfacial contact between the electrode (solid-state battery cathode 202) and solid-state electrolyte 212 and reduce interfacial resistivity. As explained in relation to the following figures, the solid-state battery cathode 202 may reduce interfacial resistivity by increasing interfacial contact between the solid-state battery cathode 202 and solid-state electrolyte 212. Additionally, the solid-state battery cathode 202 may reduce or inhibit electrolyte decomposition and thereby allow for interfacial contact between the solid-state battery cathode 202 solid-state electrolyte 212 to be maintained over extended usage. Moreover, the solid-state battery cathode 202 may increase utilization of deeply intercalated lithium ions within the solid-state battery cathode 202 structure by forming crystallite grains within the cathode particles to allow for increased lithium-ion diffusion, as well as by forming a conductive network from conductive fibers. The solid-state battery cathode 202, and corresponding solid-state battery 200, including the solid-state battery cathode 202, may have improved energy density, energy capacity, and overall cycling capabilities.

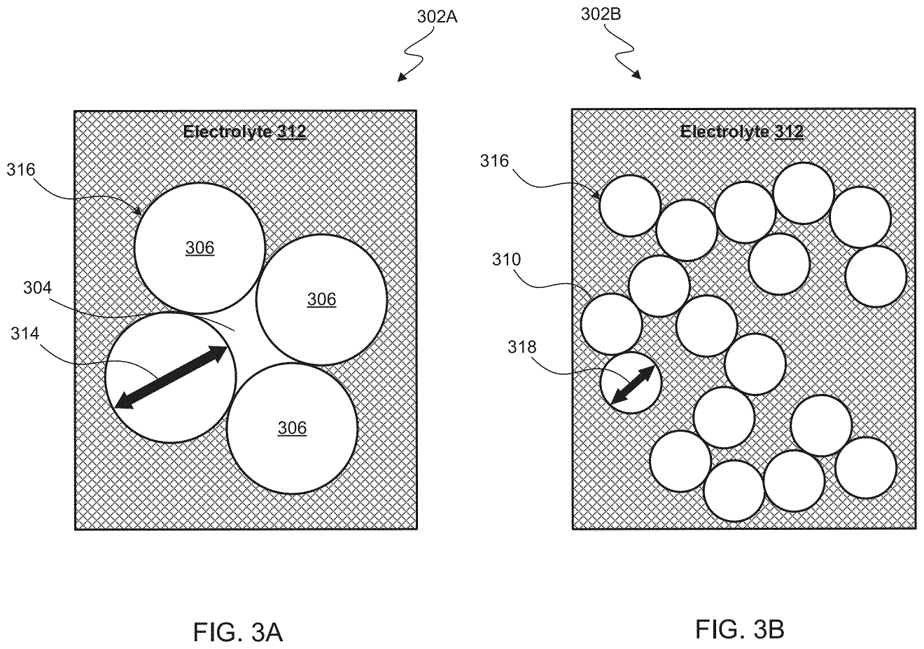

FIG. 3A illustrates a solid-state battery cathode 302A. Solid-state battery cathode 302A may include an active material and a solid-state electrolyte 312. The active material may include a plurality of particles 306. For example, the active material may include a plurality of NCA particles. The solid-state electrolyte 312 may be a solid-state electrolyte, such as solid-state electrolyte 212. Solid-state electrolyte 312 may contact one or more of particles 306 at an interface 316. Interface 316 may exist where the surface of solid-state electrolyte 312 contacts the surface of particle 306. While interface 316 may be illustrated as continuous contact between the solid surfaces of solid-state electrolyte 312 and one or more of the particles 306, the interface 316 may include inconsistent contact between the surfaces due to variation in surface features. However, interface 316 may preclude voids or vacancies between the surfaces, thereby allowing for increased conductivity and lithium ion 120 transmission between the two materials.

As noted previously, in conventional lithium-ion batteries, such as conventional battery 100, the electrolyte 112 may be a liquid. However, in solid-state batteries, such as solid-state battery 200, the solid-state electrolyte 212, or in this case solid-state electrolyte 312, is solid. Without liquid fluidity, achieving and sustaining intimate contact between solid-state electrolyte 312 and solid-state cathode material may be challenging. The periodic electrode expanding and shrinking during charging and discharging cycles further deteriorates the mechanical particle-to-particle contact. As a consequence, high polarization, and low utilization of active materials may result within solid-state battery cathode. In other words, reduced interfacial contact may result in increased resistivity within the solid-state battery cathode 202A, and an overall reduction in cathode capacity.

FIG. 3A may illustrate one of the causes of reduced interfacial contact between solid-state electrolytes and solid-state battery cathodes: large particle size. Large particle sizes may allow for high electrode density because of their increased volume. However, large particles may result in reduced capacity and poor rate performance. In part, the poor performance of solid-state batteries utilizing large particles may be due to increased interfacial resistance caused by large particles.

The plurality of particles 306 may be characterized as large particles. In embodiments, the plurality of particles 306 may be characterized by a spherical shape. Characterization as spherical in shape may mean that while each of the particles 306 are not true spheres, the general shape of the particle 306 may have a diameter or allow for the particle 306 to be measured by a diameter. The size of particles 306 may be characterized by a diameter 314 of the particles 306. The diameter 314 of the plurality of particles 306 may correspond to a D-value for the plurality of particles 306. D-values are a commonly used method of describing a particle size distribution. A D-value can be thought of as a “mass division diameter”. It is the diameter which, when all particles in a sample are arranged in order of ascending mass, divides the sample's mass into specified percentages. The percentage mass below the diameter of interest is the number expressed after the “D”. For example the D10 diameter is the diameter at which 10% of a sample's mass is comprised of smaller particles, and the D50 is the diameter at which 50% of a sample's mass is comprised of smaller particles. The D50 is also known as the “mass median diameter” as it divides the sample equally by mass. The D10, D50, and D90 are commonly used to represent the midpoint and range of the particle sizes of a given sample.

In embodiments, the diameter 314 of the plurality of particles 306 may be a D50 diameter from about 1 to about 50 μm. For example, diameter 314 may be a D50 diameter of about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, about 20 μm, about 21 μm, about 22 μm, about 23 μm, about 24 μm, about 25 μm, about 26 μm, about 27 μm, about 28 μm, about 29 μm, about 30 μm, about 31 μm, about 32 μm, about 33 μm, about 34 μm, about 35 μm, about 36 μm, about 37 μm, about 38 μm, about 39 μm, about 40 μm, about 41 μm, about 42 μm, about 43 μm, about 44 μm, about 45 μm, about 46 μm, about 47 μm, about 48 μm, about 49 μm, or about 50 μm. In some embodiments, diameter 314 may correspond to a D10 diameter, D25 diameter, D30 diameter, D40 diameter, D45 diameter, D55 diameter, D60 diameter, D70 diameter, D75 diameter, D80 diameter, D90 diameter, D95 diameter, D99 diameter, or a D100 diameter in which all the plurality of particles 306 are smaller than the D100 value within a sample.

Large particles, like the plurality of particles 306, may form void 304. Void 304 may be a large volume of closed vacancy formed by the plurality of particles 306. Void 304 may hinder direct contact, or formation of interface 316, between the particles 306 and the solid-state electrolyte 312. As described above, poor or insufficient interfacial contact (i.e., lack or reduced formation of interface 316) may cause high interfacial resistance, within the solid-state battery cathode 302A. Interfacial resistance as used herein may refer to the ease at which a lithium ion can move between the electrode and the electrolyte, and vice versa. The higher the interfacial resistivity, the more difficult it may be for the lithium ion 120 to move between the electrode and the electrolyte. As such, large particles, like particles 306 may reduce or impede lithium ion 120 intercalation and deintercalation into and out of solid-state battery cathode 302A due to increased interfacial resistivity caused by void 304.

While large particle size may negatively impact the performance of a solid-state battery, reducing particle size too small may also negatively impact the performance of the solid-state battery. Namely, when particle sizes are reduced too small, the overall electrode density becomes too low. Smaller particles inherently have smaller volumes. Thus, solid-state battery cathodes formed from smaller particles may contain lower amounts of active material, and thereby have reduced energy density. Accordingly, as provided herein, maintaining particle sizes such to achieve adequate capacity and rate performance without impacting electrode density may be favorable.

FIG. 3B illustrates a solid-state battery cathode 302B including a plurality of particles 310 having favorable particle size. Solid-state battery cathode 302B may be the same as solid-state battery cathode 302A and include the plurality of particles 310 and solid-state electrolyte 312. The particles 310 may be the same as particles 306 except for having a favorable size. Favorable particle size may be a particle size which allows or facilitates adequate or improved initial capacity and/or rate performance of a solid-state battery.

The solid-state battery cathodes as provided herein may have adequate and/or improved mechanical, chemical, electrical, and electrochemical properties. For example, the solid-state battery cathodes may have improved initial capacity and rate performance. An improved or adequate initial capacity may be about or greater than 125 mAh/g@0.1 C or even greater than 200 mAh/g@0.1 C at proper conditions. The capacity of solid-state battery cathodes may vary depending on operating conditions, such as materials (e.g., Ni content) or charge voltage. Depending on the conditions, an improved or adequate initial capacity may be about 126 mAh/g@0.1 C, about 127 mAh/g@0.1 C, about 128 mAh/g@0.1 C, about 129 mAh/g@0.1 C, about 130 mAh/g@0.1 C, about 131 mAh/g@0.1 C, about 132 mAh/g@0.1 C, about 133 mAh/g@0.1 C, about 134 mAh/g@0.1 C, about 135 mAh/g@0.1 C, about 136 mAh/g@0.1 C, about 137 mAh/g@0.1 C, about 138 mAh/g@0.1 C, about 139 mAh/g@0.1 C, about 140 mAh/g@0.1 C, about 141 mAh/g@0.1 C, about 142 mAh/g@0.1 C, about 143 mAh/g@0.1 C, about 144 mAh/g@0.1 C, about 145 mAh/g@0.1 C, about 146 mAh/g@0.1 C, about 147 mAh/g@0.1 C, about 148 mAh/g@0.1 C, about 149 mAh/g@0.1 C, about 150 mAh/g@0.1 C, about 151 mAh/g@0.1 C, about 152 mAh/g@0.1 C, about 153 mAh/g@0.1 C, about 154 mAh/g@0.1 C, about 155 mAh/g@0.1 C, about 156 mAh/g@0.1 C, about 157 mAh/g@0.1 C, about 158 mAh/g@0.1 C, about 159 mAh/g@0.1 C, about 160 mAh/g@0.1 C, about 161 mAh/g@0.1 C, about 162 mAh/g@0.1 C, about 163 mAh/g@0.1 C, about 164 mAh/g@0.1 C, about 165 mAh/g@0.1 C, about 166 mAh/g@0.1 C, about 167 mAh/g@0.1 C, about 168 mAh/g@0.1 C, about 169 mAh/g@0.1 C, about 170 mAh/g@0.1 C, about 171 mAh/g@0.1 C, about 172 mAh/g@0.1 C, about 173 mAh/g@0.1 C, about 174 mAh/g@0.1 C, about 175 mAh/g@0.1 C, about 176 mAh/g@0.1 C, about 177 mAh/g@0.1 C, about 178 mAh/g@0.1 C, about 179 mAh/g@0.1 C, about 180 mAh/g@0.1 C, about 181 mAh/g@0.1 C, about 182 mAh/g@0.1 C, about 183 mAh/g@0.1 C, about 184 mAh/g@0.1 C, 185 mAh/g@0.1 C, 186 mAh/g@0.1 C, 187 mAh/g@0.1 C, 188 mAh/g@0.1 C, 189 mAh/g@0.1 C, 190 mAh/g@0.1 C, 191 mAh/g@0.1 C, 192 mAh/g@0.1 C, 193 mAh/g@0.1 C, 194 mAh/g@0.1 C, 195 mAh/g@0.1 C, 196 mAh/g@0.1 C, 197 mAh/g@0.1 C, 198 mAh/g@0.1 C, 199 mAh/g@0.1 C, or 200 mAh/g@0.1 C.

The solid-state batteries made according this disclosure may have an improved or adequate rate performance. An improved or adequate rate performance may be a rate performance that is greater than 75% (at 2 C/0.1 C). For example, the solid-state batteries as provided herein may have a rate performance of about 76%, about 77%, about 78%, about 79%, about 80%, about 81%, about 82%, about 83%, of about 84%, of about 85%, of about 86%, of about 87%, of about 88%, of about 89%, of about 90%, of about 91%, of about 92%, of about 93%, of about 94%, of about 95%, of about 96%, of about 97%, of about 98%, of about 99%, or even at or near 100%.

The plurality of particles 310 may have a reduced size as compared to particles 306. In embodiments, the plurality of particles 310 may be characterized as spherical in shape. As described above with relation to particles 306, characterization as spherical may mean that the particles 310 have a diameter or may be measured based on a diameter, regardless of whether the particles 310 are actually spherical. The size of particles 310 may be characterized by a diameter 318. The diameter 318 of the plurality of particles 310 may correspond to a D-value for the plurality of particles 310.

In embodiments, the diameter 318 of the plurality of particles 310 may be a D50 diameter of from about 0.5 μm to 25 μm. For example, diameter 318 may be a D50 diameter from about 0.5 μm to about 25 μm, from about 0.75 μm to about 25 μm, from about 1 μm to about 25 μm, from about 2 μm to about 25 μm, from about 3 μm to about 25 μm, from about 4 μm to about 25 μm, from about 5 μm to about 25 μm, from about 6 μm to about 25 μm, from about 7 μm to about 25 μm, from about 8 μm to about 25 μm, from about 9 μm to about 25 μm, from about 10 μm to about 25 μm, from about 11 μm to about 25 μm, from about 12 μm to about 25 μm, from about 13 μm to about 25 μm, from about 14 μm to about 25 μm, from about 15 μm to about 25 μm, from about 16 μm to about 25 μm, from about 17 μm to about 25 μm, from about 18 μm to about 25 μm, from about 19 μm to about 25 μm, from about 20 μm to about 25 μm, from about 0.5 μm to about 20 μm, from about 0.75 μm to about 20 μm, from about 1 μm to about 20 μm, from about 2 μm to about 20 μm, from about 3 μm to about 20 μm, from about 4 μm to about 20 μm, from about 5 μm to about 20 μm, from about 6 μm to about 20 μm, from about 7 μm to about 20 μm, from about 8 μm to about 20 μm, from about 9 μm to about 20 μm, from about 10 μm to about 20 μm, from about 11 μm to about 20 μm, from about 12 μm to about 20 μm, from about 13 μm to about 20 μm, from about 14 μm to about 20 μm, from about 15 μm to about 20 μm, from about 16 μm to about 20 μm, from about 17 μm to about 20 μm, from about 18 μm to about 20 μm, from about 19 μm to about 20 μm, from about 0.5 μm to about 19 μm, from about 0.75 μm to about 19 μm, from about 1 μm to about 19 μm, from about 2 μm to about 19 μm, from about 3 μm to about 19 μm, from about 4 μm to about 19 μm, from about 5 μm to about 19 μm, from about 6 μm to about 19 μm, from about 7 μm to about 19 μm, from about 8 μm to about 19 μm, from about 9 μm to about 19 μm, from about 10 μm to about 19 μm, from about 11 μm to about 19 μm, from about 12 μm to about 19 μm, from about 13 μm to about 19 μm, from about 14 μm to about 19 μm, from about 15 μm to about 19 μm, from about 16 μm to about 19 μm, from about 17 μm to about 19 μm, from about 18 μm to about 19 μm, from about 0.5 μm to about 18 μm, from about 0.75 μm to about 18 μm, from about 1 μm to about 18 μm, from about 2 μm to about 18 μm, from about 3 μm to about 18 μm, from about 4 μm to about 18 μm, from about 5 μm to about 18 μm, from about 6 μm to about 18 μm, from about 7 μm to about 18 μm, from about 8 μm to about 18 μm, from about 9 μm to about 18 μm, from about 10 μm to about 18 μm, from about 11 μm to about 18 μm, from about 12 μm to about 18 μm, from about 13 μm to about 18 μm, from about 14 μm to about 18 μm, from about 15 μm to about 18 μm, from about 16 μm to about 18 μm, from about 17 μm to about 18 μm, from about 0.5 μm to about 17 μm, from about 0.75 μm to about 17 μm, from about 1 μm to about 17 μm, from about 2 μm to about 17 μm, from about 3 μm to about 17 μm, from about 4 μm to about 17 μm, from about 5 μm to about 17 μm, from about 6 μm to about 17 μm, from about 7 μm to about 17 μm, from about 8 μm to about 17 μm, from about 9 μm to about 17 μm, from about 10 μm to about 17 μm, from about 11 μm to about 17 μm, from about 12 μm to about 17 μm, from about 13 μm to about 17 μm, from about 14 μm to about 17 μm, from about 15 μm to about 17 μm, from about 16 μm to about 17 μm, from about 0.5 μm to about 16 μm, from about 0.75 μm to about 16 μm, from about 1 μm to about 16 μm, from about 2 μm to about 16 μm, from about 3 μm to about 16 μm, from about 4 μm to about 16 μm, from about 5 μm to about 16 μm, from about 6 μm to about 16 μm, from about 7 μm to about 16 μm, from about 8 μm to about 16 μm, from about 9 μm to about 16 μm, from about 10 μm to about 16 μm, from about 11 μm to about 16 μm, from about 12 μm to about 16 μm, from about 13 μm to about 16 μm, from about 14 μm to about 16 μm, from about 15 μm to about 16 μm, from about 0.5 μm to about 15 μm, from about 0.75 μm to about 15 μm, from about 1 μm to about 15 μm, from about 2 μm to about 15 μm, from about 3 μm to about 15 μm, from about 4 μm to about 15 μm, from about 5 μm to about 15 μm, from about 6 μm to about 15 μm, from about 7 μm to about 15 μm, from about 8 μm to about 15 μm, from about 9 μm to about 15 μm, from about 10 μm to about 15 μm, from about 11 μm to about 15 μm, from about 12 μm to about 15 μm, from about 13 μm to about 15 μm, from about 14 μm to about 15 μm, from about 0.5 μm to about 14 μm, from about 0.75 μm to about 14 μm, from about 1 μm to about 14 μm, from about 2 μm to about 14 μm, from about 3 μm to about 14 μm, from about 4 μm to about 14 μm, from about 5 μm to about 14 μm, from about 6 μm to about 14 μm, from about 7 μm to about 14 μm, from about 8 μm to about 14 μm, from about 9 μm to about 14 μm, from about 10 μm to about 14 μm, from about 11 μm to about 14 μm, from about 12 μm to about 14 μm, from about 13 μm to about 14 μm, from about 0.5 μm to about 13 μm, from about 0.75 μm to about 13 μm, from about 1 μm to about 13 μm, from about 2 μm to about 13 μm, from about 3 μm to about 13 μm, from about 4 μm to about 13 μm, from about 5 μm to about 13 μm, from about 6 μm to about 13 μm, from about 7 μm to about 13 μm, from about 8 μm to about 13 μm, from about 9 μm to about 13 μm, from about 10 μm to about 13 μm, from about 11 μm to about 13 μm, from about 12 μm to about 13 μm, from about 0.5 μm to about 12 μm, from about 0.75 μm to about 12 μm, from about 1 μm to about 12 μm, from about 2 μm to about 12 μm, from about 3 μm to about 12 μm, from about 4 μm to about 12 μm, from about 5 μm to about 12 μm, from about 6 μm to about 12 μm, from about 7 μm to about 12 μm, from about 8 μm to about 12 μm, from about 9 μm to about 12 μm, from about 10 μm to about 12 μm, from about 11 μm to about 12 μm, from about 0.5 μm to about 11 μm, from about 0.75 μm to about 11 μm, from about 1 μm to about 11 μm, from about 2 μm to about 11 μm, from about 3 μm to about 11 μm, from about 4 μm to about 11 μm, from about 5 μm to about 11 μm, from about 6 μm to about 11 μm, from about 7 μm to about 11 μm, from about 8 μm to about 11 μm, from about 9 μm to about 11 μm, from about 10 μm to about 11 μm, from about 0.5 μm to about 10 μm, from about 0.75 μm to about 10 μm, from about 1 μm to about 10 μm, from about 2 μm to about 10 μm, from about 3 μm to about 10 μm, from about 4 μm to about 10 μm, from about 5 μm to about 10 μm, from about 6 μm to about 10 μm, from about 7 μm to about 10 μm, from about 8 μm to about 10 μm, from about 9 μm to about 10 μm, from about 0.5 μm to about 9 μm, from about 0.75 μm to about 9 μm, from about 1 μm to about 9 μm, from about 2 μm to about 9 μm, from about 3 μm to about 9 μm, from about 4 μm to about 9 μm, from about 5 μm to about 9 μm, from about 6 μm to about 9 μm, from about 7 μm to about 9 μm, from about 8 μm to about 9 μm, from about 0.5 μm to about 8 μm, from about 0.75 μm to about 8 μm, from about 1 μm to about 8 μm, from about 2 μm to about 8 μm, from about 3 μm to about 8 μm, from about 4 μm to about 8 μm, from about 5 μm to about 8 μm, from about 6 μm to about 8 μm, from about 7 μm to about 8 μm, from about 0.5 μm to about 7 μm, from about 0.75 μm to about 7 μm, from about 1 μm to about 7 μm, from about 2 μm to about 7 μm, from about 3 μm to about 7 μm, from about 4 μm to about 7 μm, from about 5 μm to about 7 μm, from about 6 μm to about 7 μm, from about 0.5 μm to about 6 μm, from about 0.75 μm to about 6 μm, from about 1 μm to about 6 μm, from about 2 μm to about 6 μm, from about 3 μm to about 6 μm, from about 4 μm to about 6 μm, from about 5 μm to about 6 μm, from about 0.5 μm to about 5 μm, from about 0.75 μm to about 5 μm, from about 1 μm to about 5 μm, from about 2 μm to about 5 μm, from about 3 μm to about 5 μm, from about 4 μm to about 5 μm, from about 0.5 μm to about 4 μm, from about 0.75 μm to about 4 μm, from about 1 μm to about 4 μm, from about 2 μm to about 4 μm, from about 3 μm to about 4 μm, from about 0.5 μm to about 3 μm, from about 0.75 μm to about 3 μm, from about 1 μm to about 3 μm, from about 2 μm to about 3 μm, from about 0.5 μm to about 2 μm, from about 0.75 μm to about 2 μm, from about 1 μm to about 2 μm, from about 0.5 μm to about 1 μm, from about 0.75 μm to about 1 μm, or from about 0.5 μm to about 0.75 μm.

In some embodiments, diameter 318 may correspond to a D10 diameter, D25 diameter, D30 diameter, D40 diameter, D45 diameter, D55 diameter, D60 diameter, D70 diameter, D75 diameter, D80 diameter, D90 diameter, D95 diameter, D99 diameter, or a D100 diameter in which all the plurality of particles 310 are smaller than the D100 value within a sample.

A reduction in particle size may inhibit or reduce formation of voids or vacancies, such as void 304. Because smaller particles have reduced volume, formation of voids or vacancies are less likely to occur. Moreover, a reduced particle size may increase the surface area of the plurality of particles 310. The greater the surface area of the plurality of particles 310, the larger the interface 316 may be between the particles 310 and the solid-state electrolyte 312. Increasing the interface 316 between the solid surfaces of the particles 310 and the solid-state electrolyte 312 may reduce interfacial resistivity within solid-state battery cathode 302B and thereby allow for increased lithium ion 120 diffusion into and out of the solid-state battery cathode 302B. However, the size of the particles 310 may not be reduced so far as to negatively impact the electrode density.

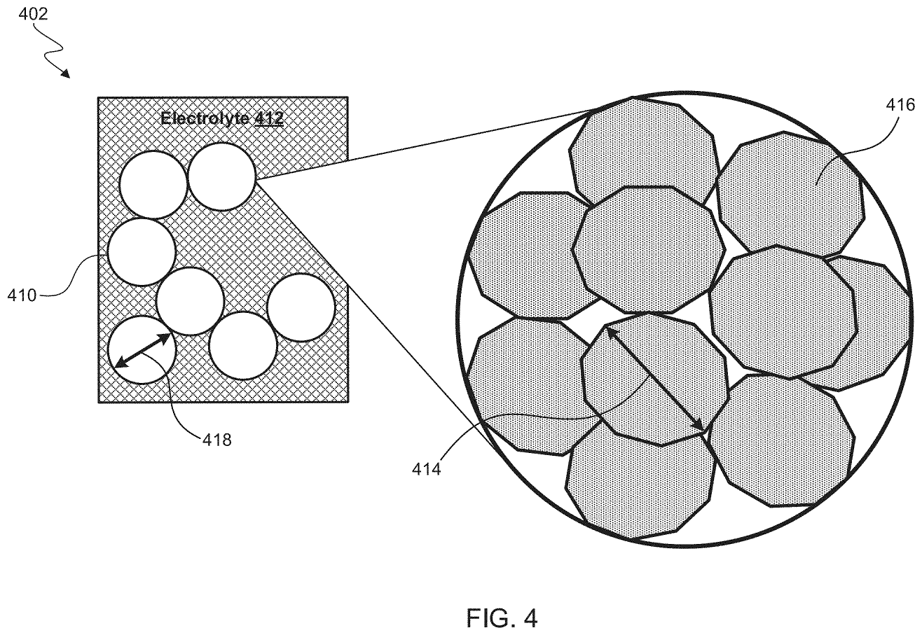

The microstructure of the plurality of particles 310 may also impact the capacity and rate performance of the solid-state battery. As illustrated by FIG. 4, the microstructure of the cathode active material may influence the overall performance of a solid-state battery cathode. FIG. 4 illustrates a solid-state battery cathode 402 including a plurality of particles 410 and a solid-state electrolyte 412. The plurality of particles 410 may be the same as the plurality of particles 310. Solid-state electrolyte 412 may be the same as solid-state electrolyte 312 and/or solid-state electrolyte 212.

As depicted, particles 410 may be contain a microstructure formed from a plurality of crystalline grains 416. The crystalline grains 416 may have a crystalline structure. Crystallinity as used herein refers to the regularity of a solid's structure. If the atoms that make up the solid material are periodic and well-ordered, crystallinity is high. If the atoms are irregular and haphazard, crystallinity is low. Low crystallinity may also be referred to as amorphous. The more amorphous a material is, the less crystalline it is, and conversely, the more crystalline the material, the less amorphous the material is.

Crystallinity may influence intercalation and deintercalation of the lithium ions 120 into and out of the plurality of particles 410. As the crystallinity of the particles 410 decreases, lithium-ion diffusion may become more difficult because the lithium ions 120 may stick or become impeded within the amorphous structure. Impeding lithium-ion diffusion may hinder ion conductivity and increase interfacial resistivity. However, as the crystallinity of the particles 410 increases, lithium-ion diffusion may more readily occur because of the regularity of the microstructure. In some cases, the regularity of the lattice structure formed by the crystalline grains 416 may facilitate ion diffusion. Higher crystallinity may also allow for utilization of lithium ions 120 which have intercalated deep within the electrode structure. Accordingly, controlling the formation, including the size of the crystalline grains 416, within the plurality of particles 410 may increase lithium-ion diffusion and reduce interfacial reactivity within the solid-state battery cathode 402.

As described in more detail with respect to Example 1, when the size of the crystalline grains 416 is too small, the initial capacity of the solid-state battery cathode 402 may be negatively impacted. For example, when the size of the crystalline grains 416 is reduced below 20 nm, then the solid-state battery cathode 402 may exhibit inadequate initial capacity (i.e., below 125 mAh/g@0.1 C). Conversely, when the size of the crystalline grains 416 is too large, then the rate performance of the solid-state battery cathode 402 may negatively impacted. For example, when the size of the crystalline grains 416 is increased above 200 nm, then the solid-state battery cathode 402 may exhibit inadequate rate performance (i.e., less than 75%). As used herein, initial capacity may refer to the state-of-charge (SOC) that the solid-state battery cathode 402 may achieve after an initial charging cycle. Rate performance may relate to the timescales associated with charge and/or ionic movement in both the solid-state battery cathode 402 and electrolyte separator (not shown in FIG. 4). Rate performance in batteries is limited because, above some threshold charge or discharge rate the maximum achievable capacity of the solid-state battery cathode 402 begins to fall off with increasing rate. This limits the amount of energy a battery can deliver at high power, or store when charged rapidly. According, initial capacity and high rate performance may be critical for rapid charging and high power delivery performance of a solid-state battery, such as solid-state battery 200.

The size of the crystalline grains 416 may be characterized by a diameter 414. In embodiments, the plurality of crystalline grains 416 may be characterized by a spherical shape. Characterization as spherical in shape may mean that while the crystalline grains 416 may not be true spheres, the general shape of the crystalline grains 416 may have a diameter 414 or allow for the crystalline grain 416 to be measured by a diameter 414. In some embodiments, the diameter 414 may be a crystallite diameter defined by the Scherrer equation. The Scherrer equation, in X-ray diffraction and crystallography, is a formula that relates the size of sub-micrometer particles, or crystallites/grains, in a solid to the broadening of a peak in a diffraction pattern. The Scherrer equation is commonly used to determine of the size of crystallites, such as crystalline grains 416.

In embodiments, the diameter 414 of the crystalline grains 416 may be from about 10 nm to about 200 nm. For example, the diameter 414 may be from about 15 nm to about 200 nm, from about 20 nm to about 200 nm, from about 25 nm to about 200 nm, from about 30 nm to about 200 nm, from about 40 nm to about 200 nm, from about 50 nm to about 200 nm, from about 60 nm to about 200 nm, from about 70 nm to about 200 nm, from about 80 nm to about 200 nm, from about 90 nm to about 200 nm, from about 100 nm to about 200 nm, from about 110 nm to about 200 nm, from about 120 nm to about 200 nm, from about 130 nm to about 200 nm, from about 140 nm to about 200 nm, from about 150 nm to about 200 nm, from about 160 nm to about 200 nm, from about 170 nm to about 200 nm, from about 180 nm to about 200 nm, from about 190 nm to about 200 nm, from about 10 nm to about 190 nm, from about 15 nm to about 190 nm, from about 20 nm to about 190 nm, from about 25 nm to about 190 nm, from about 30 nm to about 190 nm, from about 40 nm to about 190 nm, from about 50 nm to about 190 nm, from about 60 nm to about 190 nm, from about 70 nm to about 190 nm, from about 80 nm to about 190 nm, from about 90 nm to about 190 nm, from about 100 nm to about 190 nm, from about 110 nm to about 190 nm, from about 120 nm to about 190 nm, from about 130 nm to about 190 nm, from about 140 nm to about 190 nm, from about 150 nm to about 190 nm, from about 160 nm to about 190 nm, from about 170 nm to about 190 nm, from about 180 nm to about 190 nm, from about 10 nm to about 180 nm, from about 15 nm to about 180 nm, from about 20 nm to about 180 nm, from about 25 nm to about 180 nm, from about 30 nm to about 180 nm, from about 40 nm to about 180 nm, from about 50 nm to about 180 nm, from about 60 nm to about 180 nm, from about 70 nm to about 180 nm, from about 80 nm to about 180 nm, from about 90 nm to about 180 nm, from about 100 nm to about 180 nm, from about 110 nm to about 180 nm, from about 120 nm to about 180 nm, from about 130 nm to about 180 nm, from about 140 nm to about 180 nm, from about 150 nm to about 180 nm, from about 160 nm to about 180 nm, from about 170 nm to about 180 nm, from about 10 nm to about 170 nm, from about 15 nm to about 170 nm, from about 20 nm to about 170 nm, from about 25 nm to about 170 nm, from about 30 nm to about 170 nm, from about 40 nm to about 170 nm, from about 50 nm to about 170 nm, from about 60 nm to about 170 nm, from about 70 nm to about 170 nm, from about 80 nm to about 170 nm, from about 90 nm to about 170 nm, from about 100 nm to about 170 nm, from about 110 nm to about 170 nm, from about 120 nm to about 170 nm, from about 130 nm to about 170 nm, from about 140 nm to about 170 nm, from about 150 nm to about 170 nm, from about 160 nm to about 170 nm, from about 10 nm to about 160 nm, from about 15 nm to about 160 nm, from about 20 nm to about 160 nm, from about 25 nm to about 160 nm, from about 30 nm to about 160 nm, from about 40 nm to about 160 nm, from about 50 nm to about 160 nm, from about 60 nm to about 160 nm, from about 70 nm to about 160 nm, from about 80 nm to about 160 nm, from about 90 nm to about 160 nm, from about 100 nm to about 160 nm, from about 110 nm to about 160 nm, from about 120 nm to about 160 nm, from about 130 nm to about 160 nm, from about 140 nm to about 160 nm, from about 150 nm to about 160 nm, from about 10 nm to about 150 nm, from about 15 nm to about 150 nm, from about 20 nm to about 150 nm, from about 25 nm to about 150 nm, from about 30 nm to about 150 nm, from about 40 nm to about 150 nm, from about 50 nm to about 150 nm, from about 60 nm to about 150 nm, from about 70 nm to about 150 nm, from about 80 nm to about 150 nm, from about 90 nm to about 150 nm, from about 100 nm to about 150 nm, from about 110 nm to about 150 nm, from about 120 nm to about 150 nm, from about 130 nm to about 150 nm, from about 140 nm to about 150 nm, from about 10 nm to about 140 nm, from about 15 nm to about 140 nm, from about 20 nm to about 140 nm, from about 25 nm to about 140 nm, from about 30 nm to about 140 nm, from about 40 nm to about 140 nm, from about 50 nm to about 140 nm, from about 60 nm to about 140 nm, from about 70 nm to about 140 nm, from about 80 nm to about 140 nm, from about 90 nm to about 140 nm, from about 100 nm to about 140 nm, from about 110 nm to about 140 nm, from about 120 nm to about 140 nm, from about 130 nm to about 140 nm, from about 10 nm to about 130 nm, from about 15 nm to about 130 nm, from about 20 nm to about 130 nm, from about 25 nm to about 130 nm, from about 30 nm to about 130 nm, from about 40 nm to about 130 nm, from about 50 nm to about 130 nm, from about 60 nm to about 130 nm, from about 70 nm to about 130 nm, from about 80 nm to about 130 nm, from about 90 nm to about 130 nm, from about 100 nm to about 130 nm, from about 110 nm to about 130 nm, from about 120 nm to about 130 nm, from about 10 nm to about 120 nm, from about 15 nm to about 120 nm, from about 20 nm to about 120 nm, from about 25 nm to about 120 nm, from about 30 nm to about 120 nm, from about 40 nm to about 120 nm, from about 50 nm to about 120 nm, from about 60 nm to about 120 nm, from about 70 nm to about 120 nm, from about 80 nm to about 120 nm, from about 90 nm to about 120 nm, from about 100 nm to about 120 nm, from about 110 nm to about 120 nm, from about 10 nm to about 110 nm, from about 15 nm to about 110 nm, from about 20 nm to about 110 nm, from about 25 nm to about 110 nm, from about 30 nm to about 110 nm, from about 40 nm to about 110 nm, from about 50 nm to about 110 nm, from about 60 nm to about 110 nm, from about 70 nm to about 110 nm, from about 80 nm to about 110 nm, from about 90 nm to about 110 nm, from about 100 nm to about 110 nm, from about 10 nm to about 100 nm, from about 15 nm to about 100 nm, from about 20 nm to about 100 nm, from about 25 nm to about 100 nm, from about 30 nm to about 100 nm, from about 40 nm to about 100 nm, from about 50 nm to about 100 nm, from about 60 nm to about 100 nm, from about 70 nm to about 100 nm, from about 80 nm to about 100 nm, from about 90 nm to about 100 nm, from about 10 nm to about 90 nm, from about 15 nm to about 90 nm, from about 20 nm to about 90 nm, from about 25 nm to about 90 nm, from about 30 nm to about 90 nm, from about 40 nm to about 90 nm, from about 50 nm to about 90 nm, from about 60 nm to about 90 nm, from about 70 nm to about 90 nm, from about 80 nm to about 90 nm, from about 10 nm to about 80 nm, from about 15 nm to about 80 nm, from about 20 nm to about 80 nm, from about 25 nm to about 80 nm, from about 30 nm to about 80 nm, from about 40 nm to about 80 nm, from about 50 nm to about 80 nm, from about 60 nm to about 80 nm, from about 70 nm to about 80 nm, from about 10 nm to about 70 nm, from about 15 nm to about 70 nm, from about 20 nm to about 70 nm, from about 25 nm to about 70 nm, from about 30 nm to about 70 nm, from about 40 nm to about 70 nm, from about 50 nm to about 70 nm, from about 60 nm to about 70 nm, from about 10 nm to about 60 nm, from about 15 nm to about 60 nm, from about 20 nm to about 60 nm, from about 25 nm to about 60 nm, from about 30 nm to about 60 nm, from about 40 nm to about 60 nm, from about 50 nm to about 60 nm, from about 10 nm to about 50 nm, from about 15 nm to about 50 nm, from about 20 nm to about 50 nm, from about 25 nm to about 50 nm, from about 30 nm to about 50 nm, from about 40 nm to about 50 nm, from about 10 nm to about 40 nm, from about 15 nm to about 40 nm, from about 20 nm to about 40 nm, from about 25 nm to about 40 nm, from about 30 nm to about 40 nm, from about 10 nm to about 30 nm, from about 15 nm to about 30 nm, from about 20 nm to about 30 nm, from about 25 nm to about 30 nm, from about 10 nm to about 25 nm, from about 15 nm to about 25 nm, from about 20 nm to about 25 nm, from about 10 nm to about 20 nm, from about 15 nm to about 20 nm, or from about 10 nm to about 15 nm.

The diameter 414 of the crystalline grains 416 may mean that the majority (more than 50%) of the crystalline grains 416 formed within the plurality of particles 410 have a diameter 414. In some embodiments, diameter 414 may mean that more than 25% of the crystalline grains 416 have a diameter that is at or about diameter 414. For example, more than 28%, more than 30%, more than 32%, more than 35%, more than 40%, more than 45%, more than 50%, more than 55%, more than 60%, more than 65%, more than 70%, more than 75%, more than 80%, more than 85%, more than 90%, more than 95%, and in some cases all of the crystalline grains may have a diameter that is at or about diameter 414.

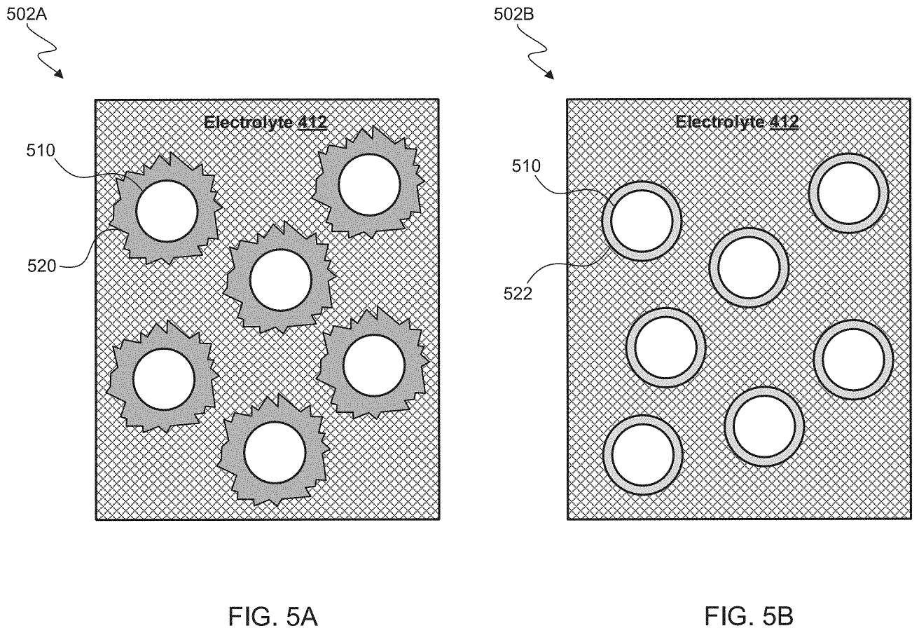

Another challenge that solid-state batteries face is interfacial reactivity between the solid-state battery cathode and the solid-state electrolyte. FIG. 5A illustrates a solid-state battery cathode 502A undergoing interfacial reactions. Solid-state battery cathode 502A may include an active material comprising a plurality of particles 510 and a solid-state electrolyte 512. The particles 510 may be the same as particles 310 or 410. Solid-state electrolyte 512 may be a solid electrolyte, such as solid-state electrolyte 412, 312 or 212.

There are many chemical, electrochemical, and mechanical stability issues at the interfaces between particles 510 and solid-state electrolyte 512. In particular, redox instability of the solid-state electrolyte 512 within the solid-state battery cathode 502A may cause for unwanted interfacial reactions 520 to occur at the interface. These interfacial reactions 520, which are sometimes referred to as side reactions, may result in an increase in interfacial resistance and may greatly degrade battery performance during repeated cycling. Because these interfacial reactions 520, for the most part, are irreversible reactions, they may be highly undesirable.

The origin of interfacial reactions 520 may be the high thermodynamic reactivity of the active material, such as the particles 510, with the solid-state electrolyte 512. Interface instability may derive from an abrupt electrochemical potential change at the electrode-electrolyte interface. During charging, lithium ions 120 are extracted from the cathode and migrate to anode via the solid electrolyte, while electrons 122 transfer from the cathode to anode through an external circuit, such as electron path 114. In this process, oxidation and reduction reactions take place at the cathode and anode sides, respectively. During discharging, the lithium ions 120 and electrons 122 migrate toward the reverse direction, accompanied with cathode reduction, and anode oxidation. During the charging and discharging cycles, the following reaction steps may occur at electrode-electrolyte interface within solid-state batteries: (i) lithium ions 120 may diffuse into the electrolyte, (ii) lithium ions 120 may hop into the first lattice site of the electrode while a oxidation/reduction reaction occurs at the same time (i.e., the charge transfer process), (iii) lithium ions 120 may diffuse into the electrode, and (iv) a surface reaction may occur.

During the above reaction steps, an abrupt change of electrical potential can occur across the electrode-electrolyte interface due to the lithium ion 120 movement. This abrupt change in electrical potential may cause interfacial reactions 520 to occur or accelerate. For example, the electric potential drop caused by polarization between the solid-state battery cathode 502A and solid-state electrolyte 512 may cause or accelerate interfacial reactions 520. Interfacial reactions 520 may accelerate due to the specific local electric potential.

In some cases, interfacial degradation may occur as a result of the interfacial reactions 520. Interfacial degradation may include electrolyte decomposition and/or formation of an intermediate transition layer or solid-electrolyte interphase (SEI) at the interface. Interfacial degradation may cause for low initial coulombic efficiency and reduce the overall working lifespan of the solid-state battery.

Interfacial degradation may also impact formation and maintenance of the electrode-electrolyte interface 316. As the electrolyte decomposes or as a solid-electrolyte interphase forms at the interface 316, interfacial contact between the particles 510 and solid-state electrolyte 512 may become impacted or even impeded. Impedance of interfacial contact between the particles 510 and solid-state electrolyte 512 may create large polarization, in addition to increasing interfacial resistivity. And as described above, generation of large polarization may act to further accelerate interfacial reactions 520, resulting in further interfacial degradation. Hence, interfacial reactions 520 may form a harmful cycle that may eventually lead to battery failure.

Apart from solid electrolyte modification, surface modification of the active material may mitigate interfacial degradation by preventing interfacial reactions 520. As illustrated by FIG. 5B, formation of a coating 522 on the plurality of particles 510 may reduce or impede interfacial reactions 520 from occurring. Solid-state battery cathode 502B may be the same as solid-state battery cathode 502A except that the plurality of particles 510 have a coating 522.

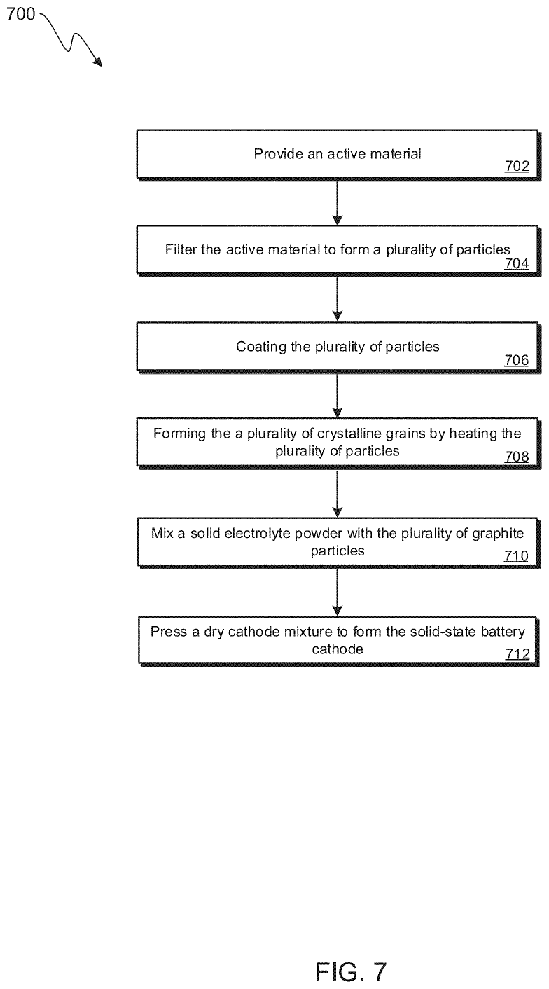

Coating 522 may be a solid-state interfacial coating. Coating 522 may be different than coatings used in conventional lithium-ion batteries, such as conventional battery 100, because of the different properties present at solid-state interfaces, such as interface 316. In some embodiments, coating 522 may include carbon-containing material. For example, in some embodiments, coating 522 may include graphene. In other cases, the coating may contain a crystalline material. Coating 522 may impede or reduce interfacial reactions 520. Further details regarding coating 522 are provided with relation to FIG. 7.

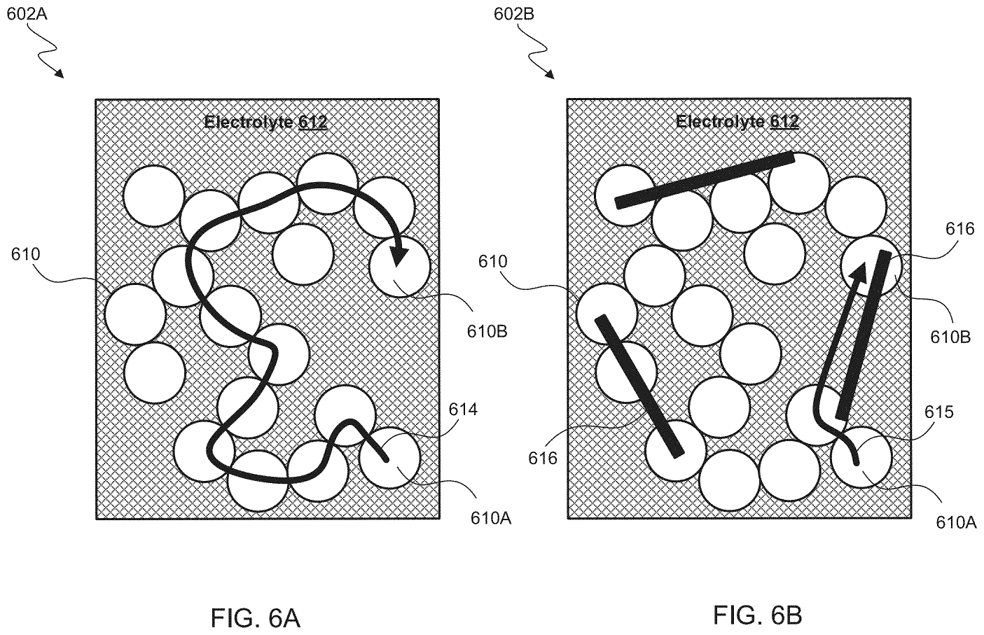

FIG. 6A illustrates an electron pathway 614 through solid-state battery cathode 602A. Solid-state battery cathode 602A may include a plurality of particles 610 and electrolyte 612. The plurality of particles 610 may be the same as particles 510, 410, and/or 310. Electrolyte 612 may be a solid-state electrolyte, such as solid-state electrolyte 512, 412, 312, and/or 212.

Electron pathway 614 may illustrate one pathway that electricity or electrons 122 may take through solid-state battery cathode 602A. Because electrolyte 612 inhibits transmission of electrons 122, the electrons 122 transferring into and out of solid-state battery cathode 602A during the charging and discharging cycles may follow a route formed along the particles 610. For example, for electrons 122 at the particle 610A to transfer to the particle 610B, the electrons 122 may take electron pathway 614. Because electron pathway 614 may cover a greater distance than a direct point-to-point distance between the particle 610A and the particle 610B, electrical resistance within solid-state battery cathode 602A may be increased.

To reduce electrical resistivity and increase electrical conductivity of solid-state cathode 602A, conductive fibers may be added to the active material. FIG. 6B illustrates a solid-state battery cathode 602B having an active material including conductive fibers 616. Solid-state battery cathode 602B may include an active material comprising a plurality of particles 610, electrolyte 612, and conductive fibers 616. The conductive fibers 616 may include carbon fibers or graphite fibers. For example, conductive fibers 616 may be vapor grown carbon fibers. Conductive fibers 616 may be interspersed between the plurality of particles 610. In some embodiments, conductive fibers 616 may contact and extend between the particles 610 such to provide shorter electron pathway 615 for electrons 122. For example, electrons 122 at the particle 610A in FIG. 6B may have a shorter path to the particle 610B along electron pathway 615. Instead of following electron pathway 614 illustrated in FIG. 6A between the particle 610A and the particle 610B, electrons 122 may follow electron pathway 615 created by conductive fiber 616. By shortening the electron pathway, the electrical resistance within solid-state battery cathode 602B may be reduced due to formation of a conductive network.

Conductive fibers 616 may form a conductive network within solid-state battery cathode 602B by creating “bridges” between particles 610 for electron transmission. To form a conductive network, at least 25% of the particles 610 may be contacted by conductive fibers 616. For example, at least 30%, at least 40%, at least 50%, at least 60%, at least 70%, at least 80%, at least 90%, at least 95%, or at least 98% of the particles 610 articles may be contacted by conductive fibers 616.

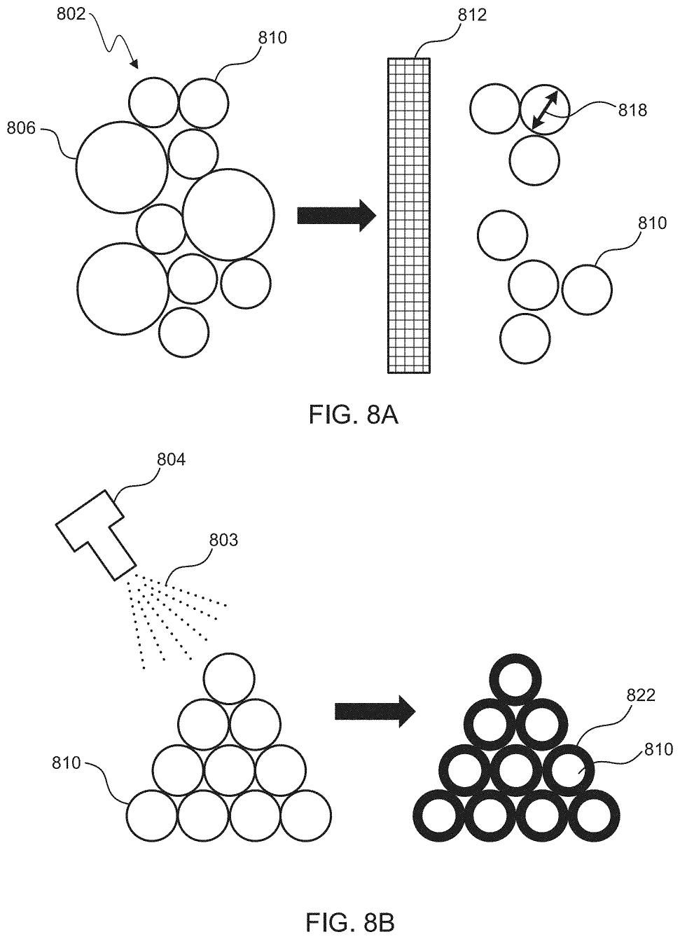

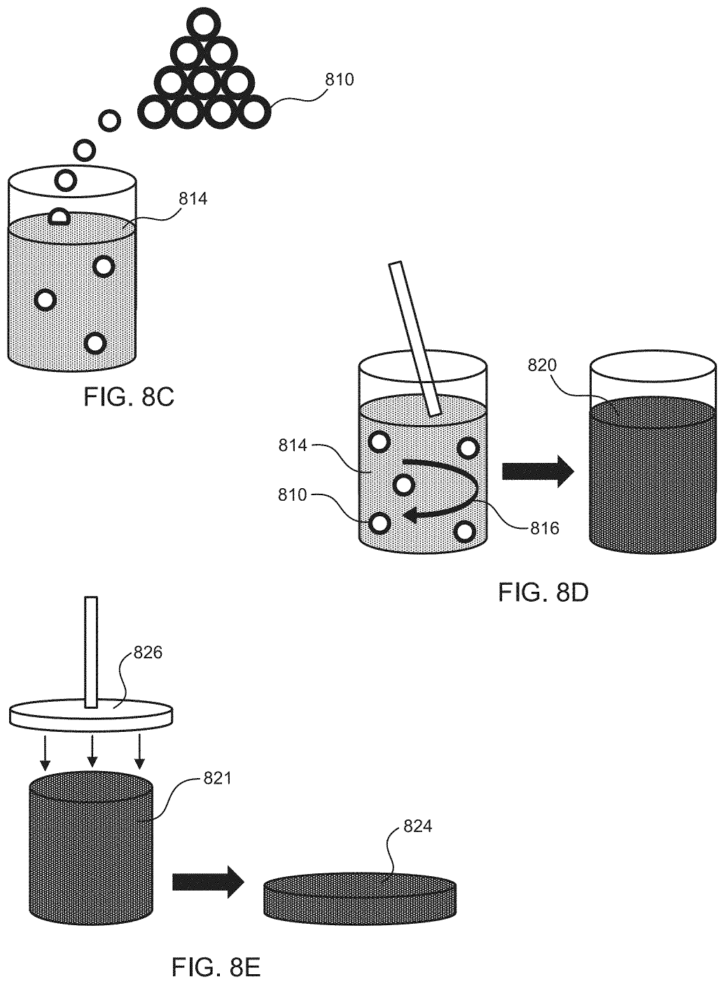

FIG. 7 illustrates a flowchart 700 of a method of making a solid-state battery cathode, according to some embodiments as provided herein, and will be discussed with reference to components of FIGS. 8A-E. The method may include providing an active material at step 702. The active material 802 may include a plurality of particles having various particle sizes. For example, as illustrated in FIG. 8A, the active material may include large particles, such as particles 806, and small particles, such as particles 810. In embodiments, the active material 802 may include NCA.

At step 704, the active material 802 may be filter to form a plurality of particles 810. Filtering the active material 802 may include sieving the active material 802 to remove large particles 806. For example, as illustrated in FIG. 8A, the active material 802 may be passed through a filter or sieve 812 to form a plurality of particles 810. In some embodiments, the active material 802 may be filtered such that the resulting plurality of particles 810 have a diameter 818. For example, the plurality of particles 810 formed at step 604 may be characterized by a D50 diameter 818 from about 5 μm to about 20 μm. In some embodiments, the plurality of particles 810 may be the same as the plurality of particles 310, 410, 510, and/or 610.

The method in flowchart 700 may also include coating the plurality of particles 810, at step 706. Coating the plurality of particles 810 may include spray coating, electro-static coating, wet coating, or any other known means of coating the plurality of particles 810. For example, as illustrated at FIG. 8A, the plurality of particles 810 may be spray coated to form a coating 822 on the particles 810. Coating 822 may be the same as coating 522. To coat the plurality of particles 810, a coating device 804 may spray a coating solution 803 onto the particles 810. The coating solution 803 may include LiOH, Zr(t-BuO)₄, and/or an ethanol solution. An exemplary coating solution 803 may include Powerex MP-1. In some embodiments, the coating device 804 may be a fluidized bed.

A plurality of crystalline grains may be formed within the plurality of particles 810 at step 708. The plurality of crystalline grains may be formed by heating the plurality of particles 810. The plurality of crystalline grains may be the same as crystalline grains 416. In some embodiments, the plurality of crystalline grains may formed via a calcination process. Calcination may include a thermal treatment. The thermal treatment may include heating the plurality of particles 810 to a high temperature and then maintaining the plurality of particles 810 at or near the high temperature for a duration of time. In some embodiments, the thermal treatment may proceed in the presence of air or oxygen. In other embodiments, the heat treatment may proceed in the absence or limited supply of air or oxygen.

During the thermal treatment, the plurality of particles 810 may be heated to a high temperature. The high temperature may be a temperature from about 250° C. to about 800° C., and preferably from about 350° C. to about 600° C. It may be undesirable to heat the plurality of particles 810 to a temperature greater than 800° C. At temperatures greater than 800° C., the active material within the plurality of particles 810 may begin to sinter. Sintered active material may result in large particle sizes and may result in reduced performance. For example, the high temperature may range from about 250° C. to about 800° C., from about 300° C. to about 800° C., from about 350° C. to about 800° C., from about 400° C. to about 800° C., from about 450° C. to about 800° C., from about 500° C. to about 800° C., from about 550° C. to about 800° C., from about 600° C. to about 800° C., from about 650° C. to about 800° C., from about 700° C. to about 800° C., from about 750° C. to about 800° C., from about 250° C. to about 750° C., from about 300° C. to about 750° C., from about 350° C. to about 750° C., from about 400° C. to about 750° C., from about 450° C. to about 750° C., from about 500° C. to about 750° C., from about 550° C. to about 750° C., from about 600° C. to about 750° C., from about 650° C. to about 750° C., from about 700° C. to about 750° C., from about 250° C. to about 700° C., from about 300° C. to about 700° C., from about 350° C. to about 700° C., from about 400° C. to about 700° C., from about 450° C. to about 700° C., from about 500° C. to about 700° C., from about 550° C. to about 700° C., from about 600° C. to about 700° C., from about 650° C. to about 700° C., from about 250° C. to about 650° C., from about 300° C. to about 650° C., from about 350° C. to about 650° C., from about 400° C. to about 650° C., from about 450° C. to about 650° C., from about 500° C. to about 650° C., from about 550° C. to about 650° C., from about 600° C. to about 650° C., from about 250° C. to about 600° C., from about 300° C. to about 600° C., from about 350° C. to about 600° C., from about 400° C. to about 600° C., from about 450° C. to about 600° C., from about 500° C. to about 600° C., from about 550° C. to about 600° C., from about 250° C. to about 550° C., from about 300° C. to about 550° C., from about 350° C. to about 550° C., from about 400° C. to about 550° C., from about 450° C. to about 550° C., from about 500° C. to about 550° C., from about 250° C. to about 500° C., from about 300° C. to about 500° C., from about 350° C. to about 500° C., from about 400° C. to about 500° C., from about 450° C. to about 500° C., from about 250° C. to about 450° C., from about 300° C. to about 450° C., from about 350° C. to about 450° C., from about 400° C. to about 450° C., from about 250° C. to about 400° C., from about 300° C. to about 400° C., from about 350° C. to about 400° C., from about 250° C. to about 350° C., from about 300° C. to about 350° C., or from about 250° C. to about 300° C.

The plurality of particles 810 may be held at the high temperature for a duration of time at step 708. The duration of time may range from about 30 minutes to 36 hours, preferably from 1 hour to 8 hours. For example, the duration of time may range from about 30 minutes to about 36 hours, from about 1 hour to about 36 hours, from about 2 hours to about 36 hours, from about 3 hours to about 36 hours, from about 6 hours to about 36 hours, from about 8 hours to about 36 hours, from about 12 hours to about 36 hours, from about 18 hours to about 36 hours, from about 24 hours to about 36 hours, from about 30 minutes to about 24 hours, from about 1 hour to about 24 hours, from about 3 hours to about 24 hours, from about 6 hours to about 24 hours, from about 8 hours to about 24 hours, from about 12 hours to about 24 hours, from about 18 hours to about 24 hours, from about 1 minute to about 18 hours, from about 30 minutes to about 18 hours, from about 1 hour to about 18 hours, from about 3 hours to about 18 hours, from about 6 hours to about 18 hours, from about 8 hours to about 18 hours, from about 12 hours to about 18 hours, from about 30 minutes to about 12 hours, from about 1 hour to about 12 hours, from about 3 hours to about 12 hours, from about 6 hours to about 12 hours, from about 8 hours to about 12 hours, from about 30 minutes to about 8 hours, from about 1 hour to about 8 hours, from about 3 hours to about 8 hours, from about 6 hours to about 8 hours, from about 30 minutes to about 6 hours, from about 1 hour to about 6 hours, from about 3 hours to about 6 hours, from about 30 minutes to about 3 hours, from about 1 hour to about 3 hours, from about 30 minutes to about 1 hour, or from about 1 minute to about 30 minutes.

During the thermal treatment, the plurality of particles 810 may undergo structural and morphological transformations. For example, during the thermal treatment, the microstructure of the particles 810 may form crystalline grains. The crystalline grain size and crystallinity may correlate with the high temperature and/or time duration of the thermal treatment. For example, crystalline grains having a diameter from about 20 nm to 150 nm may be formed from a thermal treatment heating the plurality of particles 810 to a temperature of 550° C. and holding the particles 810 at that temperature for a time duration of 2 hours.

At step 710, a solid electrolyte powder may be mixed with the plurality of particles 810 to form a dry cathode material. In some embodiments, the solid electrolyte powder may be mixed with the plurality of particles 810 before the particles 810 are coated and/or undergo the thermal treatment, while in other embodiments, the solid electrolyte powder may be mixed with the plurality of particles 810 after the particles 810 are coated and/or undergo the thermal treatment. The solid electrolyte powder may be a solid-state electrolyte. For example, the solid electrolyte powder may be the same as solid-state electrolyte 212, 312, 412, 512, and/or 612.

In some embodiments, the dry cathode material may also include a plurality of conductive fibers. In such embodiments, the conductive fibers may be mixed with the particles 810 before the particles 810 are mixed with the solid electrolyte powder. While in other embodiments, the conductive fibers may be mixed with the solid electrolyte powder before the particles 810 are mixed with the solid electrolyte powder. The conductive fibers may be the same as conductive fibers 516.

In some embodiments, the dry cathode material may include one or more additional components. For example, the dry cathode material may include a binder or an additive The amount of solid electrolyte powder, the amount of particles 810, and the amount of conductive fibers in the dry cathode mixture may vary. In some embodiments, the dry cathode mixture may include at least 5% by wt. solid electrolyte powder. For example, the dry cathode mixture may include at least 6% by wt., at least 7% by wt., at least 8% by wt., at least 9% by wt., at least 10% by wt., at least 11% by wt., at least 12% by wt., at least 13% by wt., at least 14% by wt., at least 15% by wt., at least 16% by wt., at least 17% by wt., at least 18% by wt., at least 19% by wt., at least 20% by wt., at least 21% by wt., at least 22% by wt., at least 23% by wt., at least 24% by wt., at least 25% by wt., at least 26% by wt., at least 27% by wt., at least 28% by wt., at least 29% by wt., at least 30% by wt., at least 31% by wt., at least 32% by wt., at least 33% by wt., at least 34% by wt., at least 35% by wt., at least 36% by wt., at least 37% by wt., at least 38% by wt., at least 39% by wt., at least 40% by wt., at least 41% by wt., at least 42% by wt., at least 43% by wt., at least 44% by wt., at least 45% by wt., at least 46% by wt., at least 47% by wt., at least 48% by wt., at least 49% by wt., or at least 50% by wt. solid electrolyte powder.

In some embodiments, the dry cathode mixture may include at least 50% by wt. particles 810. For example, the dry cathode mixture may include at least 51% by wt., at least 52% by wt., at least 53% by wt., at least 54% by wt., at least 55% by wt., at least 56% by wt., at least 57% by wt., at least 58% by wt., at least 59% by wt., at least 60% by wt., at least 61% by wt., at least 62% by wt., at least 63% by wt., at least 64% by wt., at least 65% by wt., at least 66% by wt., at least 67% by wt., at least 68% by wt., at least 69% by wt., at least 70% by wt., at least 71% by wt., at least 72% by wt., at least 73% by wt., at least 74% by wt., at least 75% by wt., at least 76% by wt., at least 77% by wt., at least 78% by wt., at least 79% by wt., at least 80% by wt., at least 81% by wt., at least 82% by wt., at least 83% by wt., at least 84% by wt., at least 85% by wt., at least 86% by wt., at least 87% by wt., at least 88% by wt., at least 89% by wt., at least 90% by wt., at least 91% by wt., at least 92% by wt., at least 93% by wt., at least 94% by wt., at least 95% by wt., at least 96% by wt., at least 97% by wt., at least 98% by wt., at least 99% by wt., or, in some cases, 100% by wt. particles 810.

The dry cathode mixture may include up to 20% by wt. conductive fibers. For example, the dry cathode mixture may include up to 19% by wt., up to 18% by wt., up to 17% by wt., up to 16% by wt., up to 15% by wt., up to 14% by wt., up to 13% by wt., up to 12% by wt., up to 11% by wt., up to 10% by wt., up to 9% by wt., up to 8% by wt., up to 7% by wt., up to 6% by wt., up to 5% by wt., up to 4% by wt., up to 3% by wt., up to 2% by wt., or up to 1% by wt. conductive fibers. In some embodiments, the dry cathode mixture may not include any conductive fibers.

Mixing the solid electrolyte powder with the plurality of particles 810 at step 710 may include a variety of sub-steps. In some embodiments, mixing the solid electrolyte powder with the particles 810 may include dissolving the solid electrolyte powder in an electrolyte solvent to form an electrolyte solution. The electrolyte solvent may be an anhydrous N-methylformamide solution. The concentration of the solid electrolyte powder in the electrolyte solution may vary. In some embodiments, the concentration of solid electrolyte powder in the electrolyte solution may range from about 5 mol % to about 50 mol %. For example, the concentration of solid electrolyte powder in the electrolyte solution may range from about 10 mol % to about 50 mol %, from about 15 mol % to about 50 mol %, from about 20 mol % to about 50 mol %, from about 25 mol % to about 50 mol %, from about 30 mol % to about 50 mol %, from about 35 mol % to about 50 mol %, from about 40 mol % to about 50 mol %, from about 45 mol % to about 50 mol %, from about 5 mol % to about 45 mol %, from about 10 mol % to about 45 mol %, from about 15 mol % to about 45 mol %, from about 20 mol % to about 45 mol %, from about 25 mol % to about 45 mol %, from about 30 mol % to about 45 mol %, from about 35 mol % to about 45 mol %, from about 40 mol % to about 45 mol %, from about 5 mol % to about 40 mol %, from about 10 mol % to about 40 mol %, from about 15 mol % to about 40 mol %, from about 20 mol % to about 40 mol %, from about 25 mol % to about 40 mol %, from about 30 mol % to about 40 mol %, from about 35 mol % to about 40 mol %, from about 5 mol % to about 35 mol %, from about 10 mol % to about 35 mol %, from about 15 mol % to about 35 mol %, from about 20 mol % to about 35 mol %, from about 25 mol % to about 35 mol %, from about 30 mol % to about 35 mol %, from about 5 mol % to about 30 mol %, from about 10 mol % to about 30 mol %, from about 15 mol % to about 30 mol %, from about 20 mol % to about 30 mol %, from about 25 mol % to about 30 mol %, from about 5 mol % to about 25 mol %, from about 10 mol % to about 25 mol %, from about 15 mol % to about 25 mol %, from about 20 mol % to about 25 mol %, from about 5 mol % to about 20 mol %, from about 10 mol % to about 20 mol %, from about 15 mol % to about 20 mol %, from about 5 mol % to about 15 mol %, from about 10 mol % to about 15 mol %, or from about 5 mol % to about 10 mol %.

As illustrated by FIG. 8C, step 710 may include introducing the plurality of particles 810 into the electrolyte solution 814. In some embodiments, the plurality of particles 810 may be coated before mixing into the electrolyte solution 814, while in other embodiments, the particles 810 may not be coated before mixing into the electrolyte solution 814. After the plurality of particles 810 are introduced into the electrolyte solution 814, the particles 810 may be soaked in the electrolyte solution 814 to form a cathode solution 820. In embodiments, the electrolyte solution 814 with the particles 810 may be subjected to agitation 816 to facilitate the soaking process.

The particles 810 may be soaked for a duration of time ranging from about 1 minutes to about 24 hours. For example, the particles 810 may be soaked from about 5 minutes to about 24 hours, from about 10 minutes to about 24 hours, from about 15 minutes to about 24 hours, from about 30 minutes to about 24 hours, from about 1 hour to about 24 hours, from about 3 hours to about 24 hours, from about 6 hours to about 24 hours, from about 8 hours to about 24 hours, from about 12 hours to about 24 hours, from about 18 hours to about 24 hours, from about 1 minute to about 18 hours, from about 5 minutes to about 18 hours, from about 10 minutes to about 18 hours, from about 15 minutes to about 18 hours, from about 30 minutes to about 18 hours, from about 1 hour to about 18 hours, from about 3 hours to about 18 hours, from about 6 hours to about 18 hours, from about 8 hours to about 18 hours, from about 12 hours to about 18 hours, from about 1 minute to about 12 hours, from about 5 minutes to about 12 hours, from about 10 minutes to about 12 hours, from about 15 minutes to about 12 hours, from about 30 minutes to about 12 hours, from about 1 hour to about 12 hours, from about 3 hours to about 12 hours, from about 6 hours to about 12 hours, from about 8 hours to about 12 hours, from about 1 minute to about 8 hours, from about 5 minutes to about 8 hours, from about 10 minutes to about 8 hours, from about 15 minutes to about 8 hours, from about 30 minutes to about 8 hours, from about 1 hour to about 8 hours, from about 3 hours to about 8 hours, from about 6 hours to about 8 hours, from about 1 minute to about 6 hours, from about 5 minutes to about 6 hours, from about 10 minutes to about 6 hours, from about 15 minutes to about 6 hours, from about 30 minutes to about 6 hours, from about 1 hour to about 6 hours, from about 3 hours to about 6 hours, from about 1 minute to about 3 hours, from about 5 minutes to about 3 hours, from about 10 minutes to about 3 hours, from about 15 minutes to about 3 hours, from about 30 minutes to about 3 hours, from about 1 hour to about 3 hours, from about 1 minute to about 1 hour, from about 5 minutes to about 1 hour, from about 10 minutes to about 1 hour, from about 15 minutes to about 1 hour, from about 30 minutes to about 1 hour, from about 1 minute to about 30 minutes, from about 5 minutes to about 30 minutes, from about 10 minutes to about 30 minutes, from about 15 minutes to about 30 minutes, from about 1 minute to about 15 minutes, from about 5 minutes to about 15 minutes, from about 10 minutes to about 15 minutes, from about 1 minute to about 10 minutes, from about 5 minutes to about 10 minutes, or from about 1 minute to about 5 minutes.

After the plurality of particles 810 soak in the electrolyte solution 814 to form the cathode solution 820, the cathode solution 820 may be dried to form a cathode composite 821. The cathode solution 820 may be dried using known techniques, such as for example, in a drying oven. In other embodiments, the cathode solution 820 may be dried by sitting at ambient conditions until the cathode composite 821 is formed.

At step 712, the cathode composite 821 may be pressed to form a solid-state battery cathode 824. As illustrated in FIG. 8E, a preparation machine 826 may be used to press and prepare the cathode composite 821 to form the solid-state battery cathode 824. For example, preparation machine 826 may be a mechanical milling machine. The formed solid-state battery cathode 824 from the cathode composite 821 may be the same as solid-state battery cathode 202, 302B, 402, 502B, and/or 602B.

It should be appreciated that the specific steps illustrated in FIG. 7 provide particular methods of making a solid-state battery according to various embodiments. Other sequences of steps may also be performed according to alternative embodiments. For example, alternative embodiments of the present invention may perform the steps outlined above in a different order. Moreover, the individual steps illustrated in FIG. 7 may include multiple sub-steps that may be performed in various sequences as appropriate to the individual step. Furthermore, additional steps may be added or removed depending on the particular applications. One of ordinary skill in the art would recognize many variations, modifications, and alternatives.

### EXAMPLE 1

The following

Table 1 provides data illustrating the effect of particle size and crystalline grain size on the a solid-state battery's performance. Specifically,

Table 1 illustrates the relationship between the particle size and crystalline grain size with the initial capacity and rate performance of a solid-state battery.

To prepare

Table 1, a solid-state battery assembly was prepared. To prepare the solid-state battery assembly, a cathode layer was formed. The cathode layer included an active material comprised of NCA. The active material included a plurality of particles that were coated with an interfacial coating. The interfacial coating comprised graphene. To apply the interfacial coating, a coating solution was spray coated onto the plurality of particles with a fluidized bed. The coating solution was Powerex MP-1 which contained LiOH, Zr(t-BuO)₄ and an ethanol solution. After coating the plurality of particles, the particles were subjected to a calcination process in which the particles were heated to a temperature of 550° C. and held at that temperature for 2 hours. During the calcination process, a plurality of crystalline grains formed within the plurality of particles. The calcinated particles were then coated lithium-doped zirconate (Li₂ZrO₃).

The cathode layer also included a solid electrolyte powder and conductive fibers. The conductive fibers were vapor grown carbon fibers. The solid electrolyte powder was Li₂S—P₂S₅. To mix the solid electrolyte powder with the plurality of particles, an electrolyte solution was prepared. The solid electrolyte powder was dissolved in an electrolyte solvent (N-methyl formamide) to form the electrolyte solution. After the electrolyte solution was formed, the plurality of particles were added to the electrolyte solution to form a cathode solution and allowed to soak for 30 minutes. After the soaking, the cathode solution was dried at a temperature of 150° C. for 3 hours under vacuum until the a cathode composite was formed. The cathode composite was them pressed at 18 mmϕ until a solid-state battery cathode (cathode layer) was formed.

The anode layer was formed using an anode active material. The anode active material was a silicon-containing material (Si or SiO). The anode layer also included conductive fibers and a solid electrolyte powder. The conductive fibers were vapor grown carbon fibers. The solid electrolyte powder was LPS. The anode active material, conductive fibers, and solid electrolyte powder were mixed to form a dry anode mixture. The dry anode mixture was then machine milled and pressed at 20 mmϕ until the solid-state battery anode (anode layer) was formed.

Next, the cathode layer and the anode layer stacked together and laminated in a vacuum. A positive cathode collector and a negative cathode collector were then applied. The positive cathode collector was a nickel-based collector and the negative cathode collector was an aluminum-based collector. The solid-state battery assembly was then ready for evaluation.

TABLE 1

| | Crystalline | | | |
|---|---|---|---|---|
| | Grain | Particle | Initial | Rate |
| | Diameter | Diameter | Capacity | Performance |
| Sample | (nm) | (μm) | (mAh/g @ 0.1 C) | (%2 C/0.1 C) |
| Example 1 | 10 | 5 | 110 | 86 |
| Example 2 | 20 | 5 | 135 | 85 |
| Example 3 | 50 | 5 | 145 | 85 |
| Example 4 | 100 | 5 | 150 | 87 |
| Example 5 | 150 | 5 | 140 | 86 |
| Example 6 | 200 | 5 | 135 | 70 |
| Example 7 | 50 | 9 | 145 | 80 |
| Example 8 | 50 | 15 | 140 | 78 |
| Example 9 | 50 | 21 | 140 | 65 |

For the evaluation, each example solid-state battery assembly was subjected to a series of charging and discharging cycles. For the initial capacity parameter, a constant current of 0.1 mAh/cm² was applied during the charging cycle and a constant current of 0.1 mAh/cm² was withdrawn during the discharging cycle. The energy density calculated for the initial capacity was based on the first discharge capacity. For the rate performance, a constant current of 0.5 mAh/cm² was applied during the charging cycle and a constant current of 0.5 mAh/cm² was withdrawn during the discharging cycle. For rate performance, the retention was defined as 0.5/.01×100%. Each solid-state battery assembly had a cut-off (cell) voltage of 3.0 to 4.2V.

As indicated by the bolded cells on Table 1, a desirable or adequate initial capacity may be greater than 125 mAh/g@0.1 C. Similarly, a desirable or adequate rate performance may be greater than 75% (@2 C/0.1 C).

A comparison of Examples 1 to 6 highlights the impact of crystalline grain diameter on the initial capacity and rate performance of the solid-state battery assembly. Starting with Example 1, the diameter of the crystalline grains is 10 nm while the plurality of particles have a D50 diameter of 5 μm. The diameter of the plurality of particles is held constant as the diameter of the crystalline grains is increased in Example 2 to 20 nm, in Example 3 to 50 nm, in Example 4 to 100 nm, in Example 5 to 150 nm, and in Example 6 to 200 nm. When the diameter of the crystalline grains is from 20 nm to 200 nm, the initial capacity and rate performance of the associated solid-state battery assembly are at or above 125 mAh/g@0.1 C and 75%, respectively. However, when the diameter of the crystalline grains drops below 20 nm, the initial capacity also drops below 125 mAh/g@0.1 C. Similarly, when the diameter of the crystalline grains increases to 200 nm, the rate performance suffers, dropping below 75%.

A comparison of Examples 3 and 7 to 9, highlights the impact of the particles' diameter on the initial capacity and rate performance of the solid-state battery assembly. Starting with Example 3, the diameter of the crystalline grains is 50 nm while the plurality of particles have a D50 diameter of 5 μm. The diameter of the crystalline grains is held constant at 5 nm while the diameter of the plurality of particles is increased in Example 7 to 9 μm, in Example 8 to 15 μm, and in Example 9 to 21 μm. When the diameter of the plurality of particles is from 5 μm to 20 μm, then the initial capacity and rate performance of the associated solid-state battery assembly are at or above 125 mAh/g@0.1 C and 75%, respectively.

In the foregoing specification, aspects of the invention are described with reference to specific embodiments thereof, but those skilled in the art will recognize that the invention is not limited thereto. Various features and aspects of the above-described invention may be used individually or jointly. Further, embodiments can be utilized in any number of environments and applications beyond those described herein without departing from the broader spirit and scope of the specification. The specification and drawings are, accordingly, to be regarded as illustrative rather than restrictive. Additionally, for the purposes of explanation, numerous specific details were set forth in the foregoing description in order to provide a thorough understanding of various embodiments of the present invention. It will be apparent, however, to one skilled in the art that embodiments of the present invention may be practiced without some of these specific details. In other instances, well-known structures, components, and methods are shown in illustrative form.

It should be appreciated that that any described range may include a standard deviation of up to 10% percent for either or both of the upper bound and the lower bound of the range. Additionally, when a value is described as either up to a given wt. % or at least a given wt. %, this inherently includes the bounds of 0 wt. % and 100 wt. %, respectively. Similarly, when a value is described in terms of distance, length, or size, if given using the terms ‘at least’ or ‘up to’, the value inherently has a bottom range of 0. Similarly, when a value is described as ‘greater than’ or ‘less than’, the value inherently includes a top bound of 100 (if in units of %) or a bottom bound of 0, respectively.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, the solid-state battery cathode or the solid-state battery have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A solid-state battery comprising:
a solid-state battery cathode comprising:
an active material comprising a plurality of particles provided to form the solid-state battery cathode, wherein:
the plurality of particles are characterized by a D50 diameter from about 10 μm to about 200 μm; and
the plurality of particles comprise a microstructure formed from a plurality of crystalline grains; and
a solid-state interfacial coating comprising a crystalline material, wherein the solid-state interfacial coating is coated on to the plurality of particles;
a solid-state battery anode; and
a solid electrolyte separator positioned between the solid-state battery cathode and the solid-state battery anode to form the solid-state battery.

2. The solid-state battery of claim 1, wherein the solid-state battery anode comprises:
a solid electrolyte powder, and
a plurality of anode particles mixed with the solid electrolyte powder to form the solid-state battery anode.

3. The solid-state battery of claim 1, wherein the plurality of crystalline grains are characterized by a D50 diameter of from about 2 nm to about 25 nm.

4. The solid-state battery of claim 1, wherein the solid-state battery has an initial capacity of at or above 125 mAh/g at 0.1 C and a rate performance of at or above 75% at a C-rate of 2 C and 0.1 C.

5. A solid-state battery cathode comprising:
a solid electrolyte powder;
an active material comprising a plurality of particles mixed with the solid electrolyte powder to form a solid-state battery cathode, wherein:
the plurality of particles are characterized by a D50 diameter from about 10 μm to about 200 μm; and
the plurality of particles comprise a microstructure formed from a plurality of crystalline grains; and
a solid-state interfacial coating comprising a crystalline material, wherein the solid-state interfacial coating is coated on to the plurality of particles to reduce interfacial reactivity between the plurality of the particles and the solid electrolyte powder within the solid-state battery cathode.

6. The solid-state battery cathode of claim 5, wherein the plurality of crystalline grains are characterized by a diameter from about 2 μm to about 25 μm.

7. The solid-state battery cathode of claim 5, wherein the plurality of particles are characterized by a spherical shape.

8. The solid-state battery cathode of claim 5, wherein the solid-state interfacial coating comprises graphene.

9. The solid-state battery cathode of claim 5 further comprising a plurality of conductive fibers, wherein the plurality of conductive fibers are interspersed between the plurality of particles within the solid-state battery cathode.

10. The solid-state battery cathode of claim 9, wherein the plurality of conductive fibers comprise vapor grown carbon fibers.

11. The solid-state battery cathode of claim 5, wherein the solid electrolyte powder comprises a sulfur-based solid electrolyte.

12. A method of making a solid-state battery cathode, the method comprising:
providing an active material;
filtering the active material to form a plurality of particles characterized by a D50 diameter from about 10 μm to about 200 μm;
coating the plurality of particles with an interfacial coating;
forming a plurality of crystalline grains within the plurality of particles by heating the plurality of particles to a temperature from about 350° C. to about 600° C.;
mixing a solid electrolyte powder with the plurality of particles to form a dry cathode mixture; and
pressing the dry cathode mixture to form the solid-state battery cathode.

13. The method of making the solid-state battery cathode of claim 12, wherein mixing the solid electrolyte powder with the plurality of particles comprises:
dissolving the solid electrolyte powder in an electrolyte solvent to form an electrolyte solution;
mixing the plurality of particles and the electrolyte solution to form a cathode solution;
drying the cathode solution to form a cathode composite; and
pressing the cathode composite to form the solid-state battery cathode.

14. The method of claim 12, wherein heating the plurality of particles comprises calcination.

15. The method of claim 12, wherein the plurality of crystalline grains are characterized by a diameter of from about 20 nm to about 150 nm.

16. The method of claim 13, wherein the electrolyte solution comprises anhydrous N-methylformamide.

17. The method of claim 13, wherein a concentration of the solid electrolyte powder in the electrolyte solution is from about 15 mol % to about 30 mol %.

18. The method of claim 13, wherein drying the cathode solution comprises maintaining the cathode solution at a temperature of from about 100° C. to 200° C. for about 1 hour to 3 hours under vacuum.

19. The method of claim 12, wherein coating the plurality of particles comprises spray coating the plurality of particles in a fluidized bed with a coating solution.

20. The method of claim 19, wherein the coating solution comprises LiOH, Zr(t-BuO)₄, or ethanol.
